(19) United States
(12) Patent Application Publication
(10) Pub. No.: US 2010/0285392 A1
(43) Pub. Date: Nov. 11, 2010

(54) ELECTROCATALYSTS FOR FUEL CELLS

(75) Inventors: Yossef A. Elabd, Philadelphia, PA (US); Yury Gogotsi, Warminster, PA (US); Benjamin Eirich, Wenonah, NJ (US); Daniel Shay, Lebanon, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Drexel University, Philadelphia, PA (US)

(21) Appl. No.: 12/680,044

(22) PCT Filed: Sep. 26, 2008
(86) PCT No.: PCT/US08/77804

§ 371 Date: Jun. 24, 2010

Related U.S. Application Data
(60) Provisional application No. 60/975,899, filed on Sep. 28, 2007.

(51) Int. Cl. B01J 27/20; C01B 31/30; B32B 5/16; H01M 8/10; H01M 8/08; H01M 8/04; H01M 4/133

(52) U.S. Cl. 429/484; 423/439; 428/402; 429/498; 429/512; 429/532; 502/177

(57) ABSTRACT

Disclosed are metallized carbonaceous materials, processes for forming such materials, and electrodes and fuel cells comprising the disclosed materials.

### CROSS-REFERENCE TO RELATED APPLICATIONS

This application claims the benefit of U.S. Provisional Application No. 60/975,899 filed Sep. 28, 2007, the entirety of which is incorporated by reference herein.

### FIELD OF THE INVENTION

The present invention pertains to the field of nanostructured materials. The present invention also pertains to the field of metallizing carbonaceous materials.

### BACKGROUND OF THE INVENTION

Various scientific and patent publications are referred to herein. Each is incorporated by reference in its entirety.

Fuel cells are attractive because they provide an innovative alternative to current power sources with higher efficiencies, renewable fuels, and a lower environmental cost. They can produce energy for a variety of applications ranging from portable electronics to power plants. The hydrogen-fueled polymer electrolyte membrane (PEM) fuel cell, in particular, has generated interest for large market applications, such as transportation. However, high cost and limited lifetime performance are two factors that hinder commercialization.

Currently, precious metal (platinum) electrodes contribute to over about 30% of the fuel cell stack cost. Typically catalysts used in fuel cells are platinum (Pt) supported on carbon (Pt/C) at catalyst contents of ˜20-50 wt %, where Pt particles about 2-4 nm in diameter are supported on carbon particles about 20 nm in size. Current anode and cathode catalyst layers (electrodes) in PEM fuel cells have Pt loadings about 3-4 times the target values required for large-scale automotive applications, which is sub-optimal for reasons of both cost and Pt supply limitations. Accordingly, reducing cost and increasing performance, increasing available Pt surface area and reducing overall Pt loadings is a future goal in PEM fuel cells.

Further, voltage losses >10 μV/hr have been observed in fuel cell lifetime tests, where <<10 μV/hr are required for automotive applications. These large voltage losses have been ascribed to Pt coarsening (agglomeration or reduction in Pt reactive surface area) and dissociation from the carbon support and also oxidative degradation of the carbon support itself. Both cost and lifetime performance are directly linked to Pt surface area (Pt loading and Pt particle size) and Pt/C stability.

Thus, there is a need in the art for methods for producing fuel cells having increased metallic surface area at reduced levels of metal loading. There is also a need for such fuel cells.

### SUMMARY OF THE INVENTION

In meeting the described challenge, disclosed are methods for metallizing a carbonaceous material, comprising forming a plurality of charged groups on a surface of the carbonaceous material, contacting the plurality of charged groups with a salt comprising a plurality of metallic ions, the contacting giving rise to a plurality of metallic ions binding to the plurality of charged groups; and neutralizing the charge on at least a portion of the plurality of bound metallic ions with a chemical agent so as to give rise to a plurality of metallic nanoparticles bound to the surface of the carbonaceous material.

Also disclosed are metallized carbonaceous compositions, comprising a plurality of carbonaceous pores characterized as having a total specific surface area of between about 300 m²/g and about 5000 m²/g, as measured by the Brunauer-Emmet-Teller method; and a plurality of metallic nanoparticles bound to at least a portion of the plurality of pores, the plurality of metallic nanoparticles being present in a range of from about 1 to about 100 weight percent based on total weight of the composition.

Further provided are electrodes, comprising an electrolytic material, a porous carbonaceous composition in contact with the electrolytic material, the porous carbonaceous composition characterized as comprising a total specific surface area of between about 300 m²/g and about 5000 m²/g, as measured by the Brunauer-Emmet-Teller method; and a plurality of metallic nanoparticles, at least a portion of the plurality of metallic nanoparticles being bound to at least a portion of the porous carbonaceous composition.

Additionally provided are energy cells, comprising an electrolytic material separating an anode and a cathode, at least a portion of the anode, at least a portion of the cathode, or both, being in contact with a carbonaceous composition, the carbonaceous composition characterized as comprising a total specific surface area of between about 300 m²/g and about 5000 m²/g, as measured by the Brunauer-Emmet-Teller method; and a plurality of metallic nanoparticles bound to at least a portion of the carbonaceous composition.

The claimed invention also discloses methods for metallizing a carbonaceous material, comprising forming a plurality of charged groups on a surface of the carbonaceous material, contacting the plurality of charged groups with a salt comprising a plurality of metallic ions, the contacting giving rise to a plurality of metallic ions binding to the plurality of charged groups; and neutralizing the charge on at least a portion of the plurality of bound metallic ions so as to give rise to a plurality of metallic nanoparticles bound to the surface of the carbonaceous material, the plurality of metallic nanoparticles characterized as comprising an average characteristic cross-sectional dimension in the range of from about 1 nm to about 60 nm, and the metallic nanoparticles being present in a range of greater than about 1 weight percent based on the total weight of the composition.

Further provided are methods for metallizing a carbonaceous material, comprising forming a plurality of charged groups on a surface of the carbonaceous material, the carbonaceous material characterized as comprising a total specific surface area of between about 300 m²/g and about 5000 m²/g, as measured by the Brunauer-Emmet-Teller method; contacting the plurality of charged groups with a salt comprising a plurality of metallic ions, the contacting giving rise to a plurality of metallic ions binding to the plurality of charged groups; and neutralizing the charge on at least a portion of the plurality of bound metallic ions with a so as to give rise to a plurality of metallic nanoparticles bound to the surface of the carbonaceous material.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1.1 is a schematic view of the traditional process of physically adsorbing metallic particles onto the surfaces of carbon black;

FIG. 1.2 is a TEM image of an E-TEK commercially available catalyst of 20% Pt/C ratio;

FIG. 1.3 is an illustration of the platinum particle size distribution in the catalyst shown in FIG. 1.2 as reported in Antolini et al. (2001);

FIG. 1.4 is a size distribution of the platinum particles in the catalyst shown in FIG. 1.2, as determined by Applicants;

FIG. 1.5 is a schematic illustration of the oxidation of the surface of a carbon black particle;

FIG. 1.6 is a schematic illustration of an ion-exchange between metallic salts and positively- and negatively-charged carbon particle surfaces;

FIG. 1.7 is a schematic illustration of the claimed metallization process;

FIG. 2.0 is a prior art schematic illustration of a generic fuel cell;

FIG. 2.1 is a schematic illustration of a fuel cell according to the claimed invention;

FIG. 4.1 is TEM images of (a) VXC72R (commercial catalyst, E-TEK, www.etek-inc.com) as-received, (b) VXC72R oxidized with nitric acid and potassium permanganate, (c) CDC as received and (d) CDC oxidized with nitric and potassium permanganate;

FIG. 4.2 shows a TEM image of as-received VXC72R;

FIG. 4.3 shows the dependence of carbon particle size with treatment protocol and carbon acid content;

FIG. 4.4 shows the maximum achieved carbon acid content for various supports with respect to specific surface area;

FIG. 4.5 shows the Raman spectrum of as-received VXC72R and oxidized VXC72R with varying carbon acid content;

FIG. 4.6 shows Raman spectra of as-received and oxidized KJ300 and as received and oxidized KJ600;

FIG. 4.7 shows Raman spectra of as received and oxidized KJ600;

FIG. 4.8 is a TEM image of carbon supported platinum commercial catalyst (E-TEK);

FIG. 4.9 illustrates TEM images of carbon support platinum catalysts prepared by the glycol-complex route;

FIG. 4.10 shows final catalyst platinum loading (wt. %) as a function of TAPH concentration;

FIG. 4.11 shows a plot of 1/Θ with respect to 1/[TAPH];

FIG. 4.12 (a) and (b) are TEM images of ion-exchanged carbon supported platinum catalysts reduced with NaBH4;

FIG. 4.13 is a TEM image of an ion-exchanged carbon supported platinum catalyst thermally reduced under an inert atmosphere;

FIG. 4.14 shows TEM images of an ion-exchanged carbon supported platinum catalyst;

FIG. 4.15 compares the platinum particle size distributions for commercial (E-TEK) and experimental (ion-exchanged) carbon supported catalysts;

FIG. 4.16 shows TEM images of CDC supported platinum catalyst;

FIG. 4.17 illustrates a particle size analysis of the CDC supported catalyst;

FIG. 4.18 illustrates an ion-exchanged carbon supported platinum catalyst that was thermally reduced;

FIG. 4.19 illustrates TEM images of the carbon supported platinum catalysts prepared by secondary plating of platinum with NaBH4;

FIG. 4.20 illustrates platinum catalyst loading as a function of carbon acid content for ion-exchanged catalysts;

FIG. 4.21 presents mean particle size data as a function of platinum catalyst loading for carbon supported commercial catalysts (▪), ion-exchanged carbon supported catalysts (∘) and ion-exchanged CDC supported catalyst (□);

FIG. 5.7 PEMFC performance for commercial catalyst and experimental catalyst prepared by the glycol-method, described elsewhere herein;

FIG. 5.8 PEMFC polarization curves using Pt catalysts supported with VXC72R and KJ300;

FIG. 5.9 compares PEMFC performance for an ion-exchanged catalyst and a catalyst prepared by the method of secondary plating;

FIG. 5.10 PEMFC performance for an ion-exchanged catalyst supported on CDC;

FIG. 5.11 compares PEMFC performance for commercial catalyst, as-received and chemically oxidized in nitric acid;

FIG. 5.12 conductivities for carbon-Nafion® composites as well as for a hydrated Nafion® PEM;

FIG. 5.13 compares PEMFC performance for oxidized commercial catalyst with varying Nafion® electrode content;

FIG. 5.14 compares the PEMFC performance using commercial catalysts with different catalyst ink compositions.

FIG. 5.15 compares the PEMFC performance using ion-exchanged catalysts with different catalyst ink compositions;

FIG. 5.16 is a scanning electron micrograph of a GDL (as-received, E-TEK); and

FIG. 5.17 is a direct comparison of PEMFC performance using ion-exchanged catalyst and commercial catalysts.

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention that are, for clarity, described herein in the context of separate embodiments, may also be provided in combination in a single embodiment. Conversely, various features of the invention that are, for brevity, described in the context of a single embodiment, may also be provided separately or in any subcombination. Further, references to values stated in ranges include each and every value within that range.

Disclosed are methods for metallizing a carbonaceous material. The methods include forming a plurality of charged groups on a surface of the carbonaceous material, contacting the plurality of charged groups with a salt comprising a plurality of metallic ions, the contacting giving rise to a plurality of metallic ions binding to the plurality of charged groups; and neutralizing the charge on at least a portion of the plurality of bound metallic ions with a chemical agent so as to give rise to a plurality of metallic nanoparticles bound to the surface of the carbonaceous material.

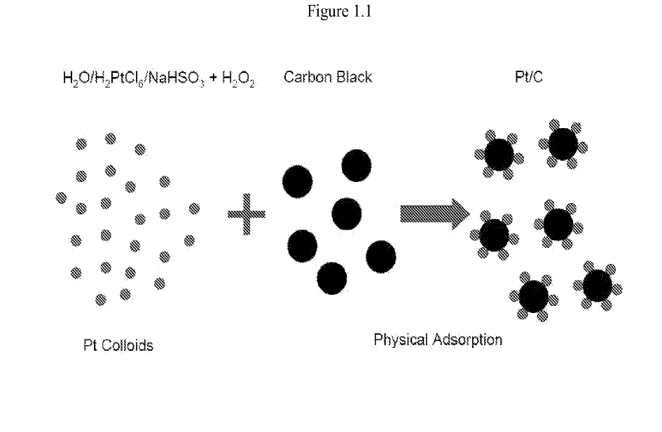

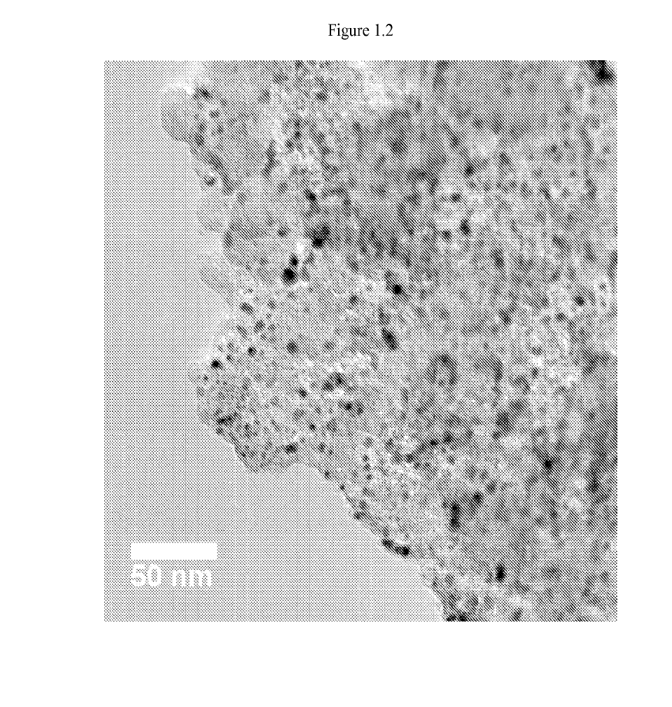

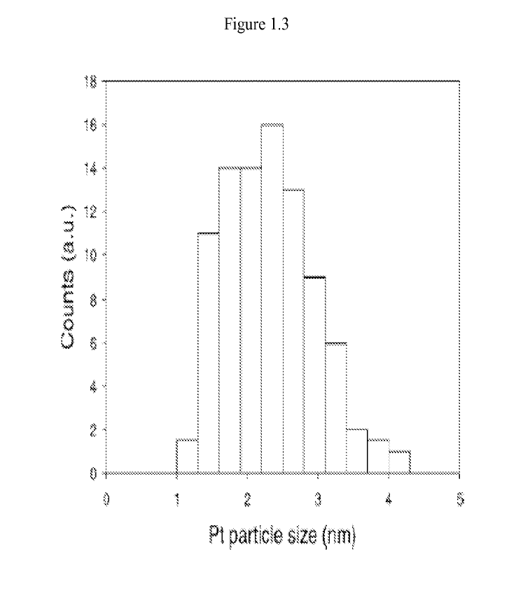

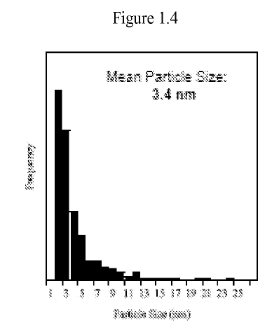

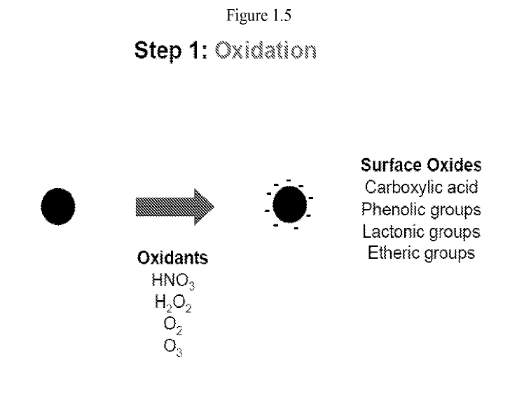

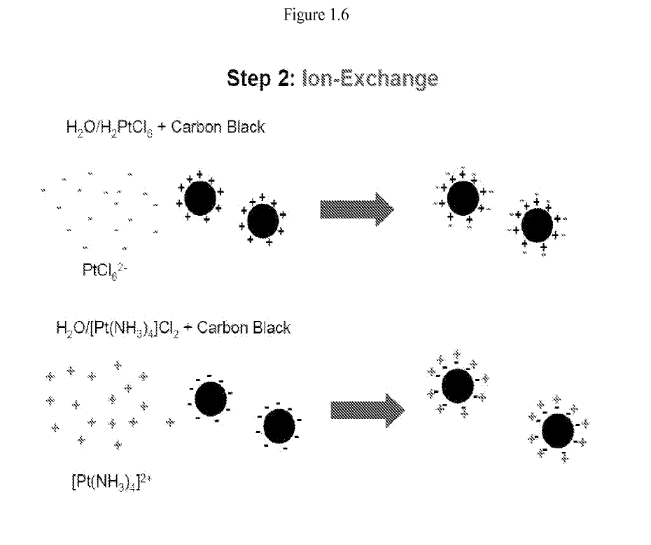

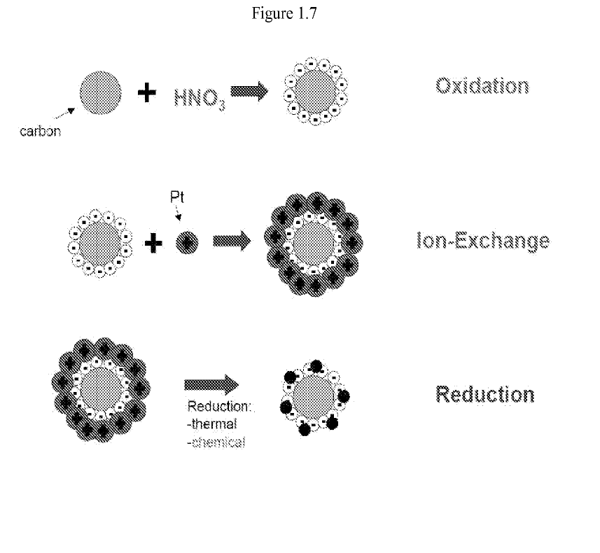

Forming the plurality of charged groups on a surface of the carbonaceous material typically includes contacting the carbonaceous material with an oxidant. Suitable oxidants include nitric acid, hydrogen peroxide, oxygen, ozone, or any combination thereof. FIG. 1.5 depicts a non-limiting, schematic oxidation process. As will be apparent, however, to one of ordinary skill in the art, a carbon surface may be either oxidized or reduced to as to give rise to charged groups on that surface.

Charged groups suitable for use in the claimed invention include carboxylic acids, phenolic groups, lactonic groups, etheric groups, or any combination thereof. Other charged groups, whether having positive or negative charges, will be apparent to those having ordinary skill in the art.

Metallic salts suitable for use in the claimed invention include, inter alia, Platinum (IV) oxide, PtO₂, Adams Catalyst, PtO₂—H₂O, Platinum(II) chloride PtCl₂, Hexahydroxyplatinic acid H₂—[Pt(OH)₆], Platinum (IV) chloride PtCl₄, Ammonium chloroplatinite (NH₄)₂[PtCl₄], Potassium hexahydroxyplatinate K₂[Pt(OH)₆], Potassium chloroplatinite K₂[PtC₄], Chloroplatinic acid; CPA Crystal H₂[PtCl₆]nH₂O, Chloroplatinic acid solution H₂[PtCl₆] (solution), Bromoplatinic acid H₂[PtBr₆]nH₂O, Sodium chloroplatinate hydrate Na₂[PtCl₆]×H₂O, Potassium chloroplatinate K₂[PtCl₆], Tetraammineplatinum(II) chloride hydrate Pt TPC crystal [Pt(NH₃)₄]Cl₂.nH₂O, Tetraammineplatinum(II) chloride solution Pt TPC solution [Pt(NH₃)₄]Cl₂, Hydrogen dinitrosulphatoplatinate(II) solution Pt DNS solution H₂[Pt(NO₂)₂SO₄] (solution), Dinitrodiammineplatinum Pt salt in ammoniacal solution [Pt(NH₃)₂(NO₂)₂], Tetraammineplatinum(II) nitrate solution [Pt(NH₃)₄(NO₃)₂ (solution), Sodium chloroplatinite solution Na₂[PtCl₄] (solution), Sodium hexahydroxyplatinate solution Na₂[Pt(OH)₆] (solution), Tetraammineplatinum hydroxide solution [Pt(NH₃)₄](OH)₂ (solution), Tetraammineplatinum hydrogen phosphate Pt Q-Salt—solution [Pt(NH₃)₄]HPO₄ (solution), Potassium trichloroammineplatinate(II) K[Pt(NH₃)Cl₃], Trans-diamminedichloroplatinum(II) trans[Pt(NH₃)₂Cl₂], Cis-diamminedichloroplatinum(II) cis[PtNH₃)₂Cl₂], Cis-dichlorobis(benzonitrile)platinum (II) PtCl₂(C₆H₅CN)₂, Cis-dichlorobis(acetonitrile)platinum(II) cisPt(CH₃CN)₂Cl₂, Bis(acetylacetonato)platinum(II) Pt(C₅H₇O₂)₂, Dichloro(norbornadiene)platinum(II) PtCl₂(C₇H₈), (Cycloocta-1,5-diene)diiodoplatinum(II) Ptl₂(C₈H1₂), Di-m-chlorodichlorobis(cyclohexene)diplatinum(II) [PtCl₂(C₆H₁₀)]₂, Potassium trichloro(ethylene)platinate(II) hydrate Zeise's Salt K[PtCl₃(C₂H₄)].H₂O, Cis-dichlorobis(triphenylphosphine)platinum(II) PtCl₂(PPh₃)₂, Potassium tetranitroplatinate(II) K₂[Pt(NO₂)₄]. Trans-dichlorobis(diethylsulphide)platinum(II) trans-PtCl₂(Et2S)₂, Cis-dichlorobis(triphenylphosphite)platinum(II) Pt[P(OPh)₂]₂Cl₂, Cis-dichlorobis(diethylsulphide)platinum(II) cis PtCl₂(Et₂S)₂, Potassium tetracyanoplatinate(II) K₂[PtCN)₄], Dichloro(1,5-cyclooctadiene)platinum(II) PtCl₂(C₈H₁₂), or any combination thereof.

Other metallic salts suitable for use where the carbonaceous material comprises positively- or negatively-charged groups will be apparent to those having ordinary skill in the art. The choice of salt may depend on the desired product or application.

Without being bound to any single theory of operation, the contacting of the metallic salt to the charged groups is characterized as an ion-exchange. A sample schematic ion-exchange is illustrated in FIG. 1.6, where the interactions of suitable metallic salts with positively- and negatively-charged carbon black particles are shown. The metallic salt suitably exchanges a plurality of metallic ions with at least a portion of the plurality of charged groups on the surface of the carbonaceous material.

Chemical agents suitable for neutralizing the charge on bound metallic ions include compositions having hydrazine or sodium borohydride. Sodium dithionite and formaldehyde are also considered suitable, as are combinations of the foregoing chemical agents. Additional suitable chemical agents suitable for charge neutralization will be apparent to those of skill in the art.

FIG. 1.7 depicts a schematic view of the oxidation, ion-exchange, and reduction aspects of the claimed process. The chemical agents identified in FIG. 1.7, however, are illustrative only and do not necessarily limit the scope of the claimed invention.

In some embodiments, the claimed method further includes the step of washing at least a portion of the plurality of bound metallic ions. Washing includes contacting at least a portion of the plurality of bound metallic ions with deionized water, and, in some embodiments, further includes the step of filtering the washed bound metallic ions; filtering may be performed under a vacuum and, in some embodiments, is followed by drying in an oven or other heat source. Other suitable washing media will be apparent to those having ordinary skill in the art.

The claimed methods suitably include a secondary plating step. The secondary plating step includes, in some embodiments, adsorbing colloidal metal to the surface of the carbonaceous material, as shown in FIG. 1.1. In other embodiments, the secondary plating step entails contacting the carbonaceous material with a metallic salt followed by contacting the carbonaceous material with a chemical reductant. This is suitably accomplished as already described elsewhere herein. In one non-limiting embodiment of the secondary plating step, the metallic salt includes Pt(NH₃)₄Cl₂ in a basic medium, and the chemical reductant includes sodium borohydride. Other metallic salts and reductants will be apparent to those of ordinary skill in the art.

The plurality of bound metallic nanoparticles is suitably characterized as having a characteristic cross-sectional dimension of from about 1 nm to about 50 nm, or from about 1 nm to about 20 nm, or of from about 1 nm to about 15 nm, or even of from about 1 nm to about 5 nm.

The plurality of bound metallic nanoparticles is present in the range of from about 1 to about 100 weight percent based on total weight of the composition, or in the range of from about 5 to about 90 weight percent based on total weight of the composition, or even in the range of from about 15 to about 50 weight percent based on total weight of the composition. The weight percentage—or loading—of metal for a given process will be dictated by the needs of the user, or by other considerations, such as, e.g., cost.

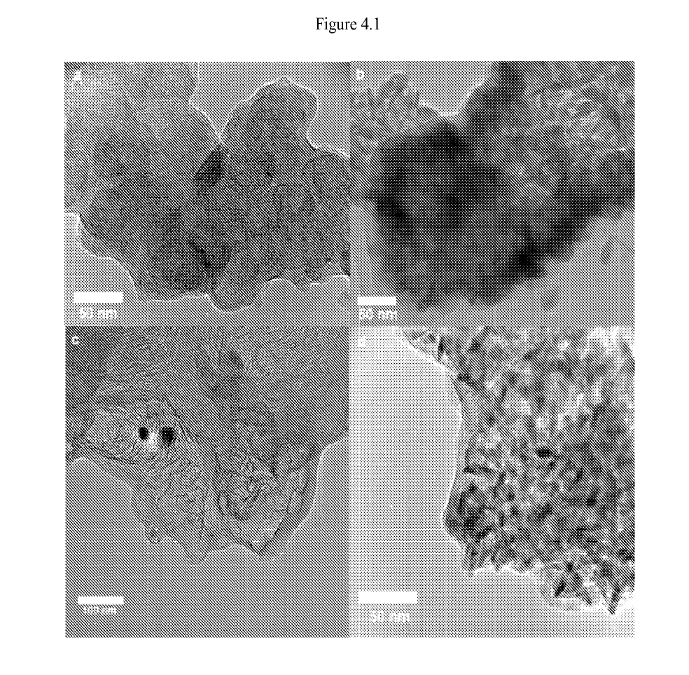

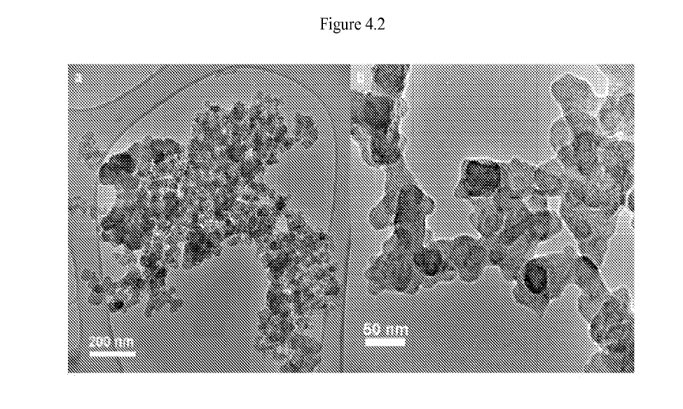

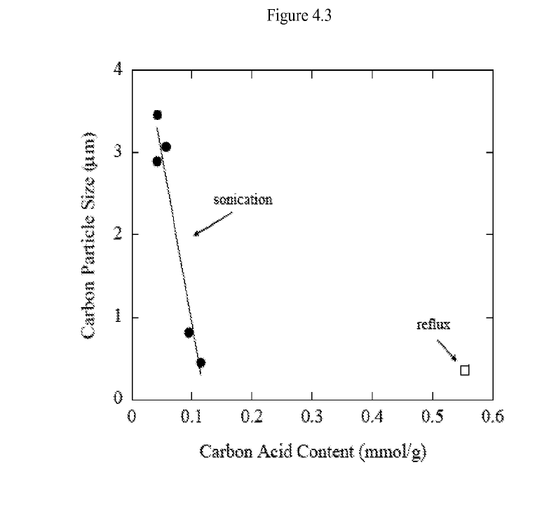

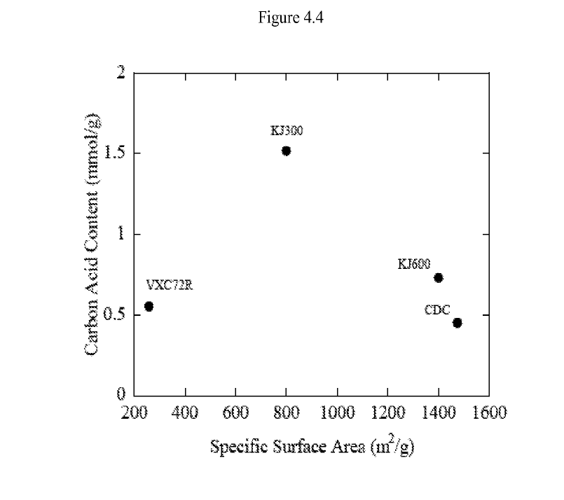

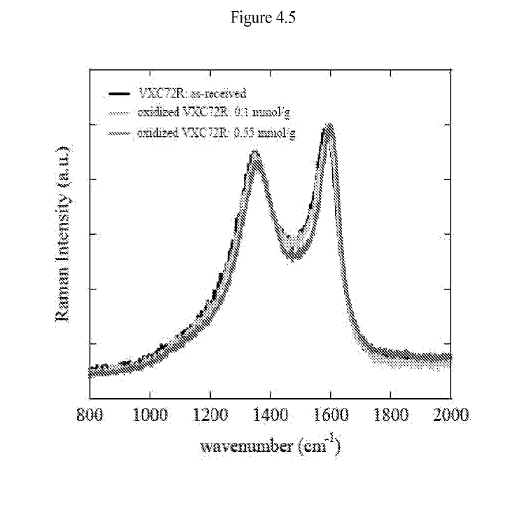

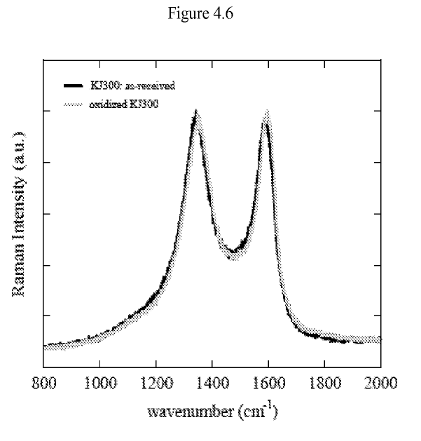

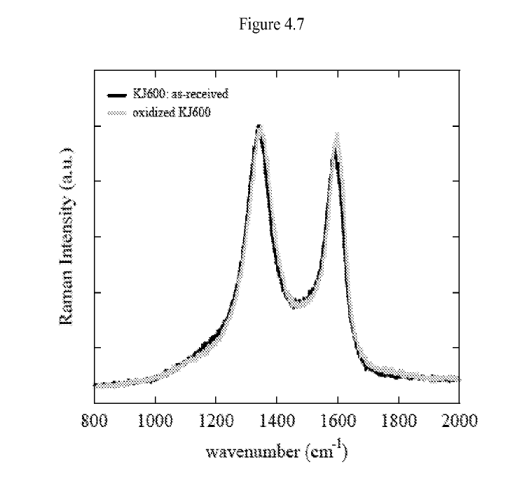

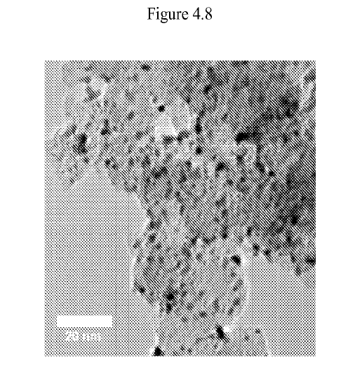

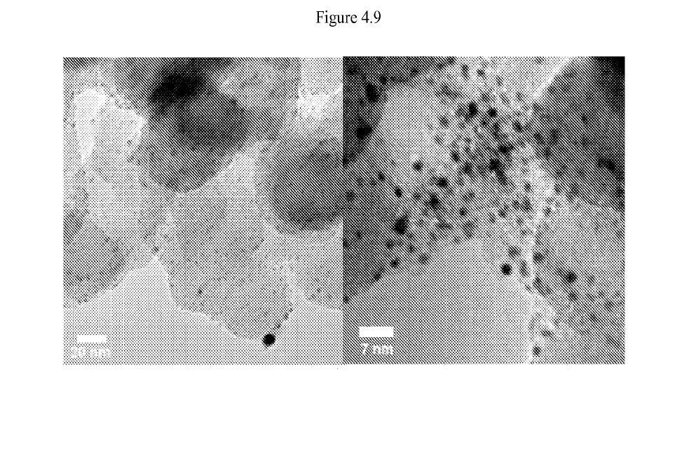

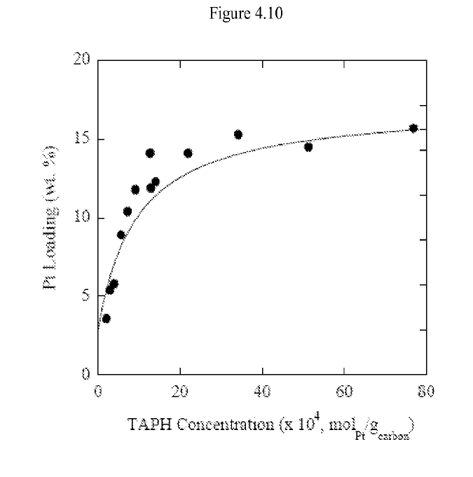

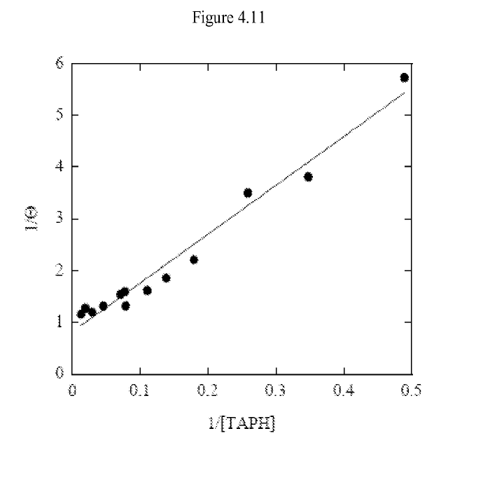

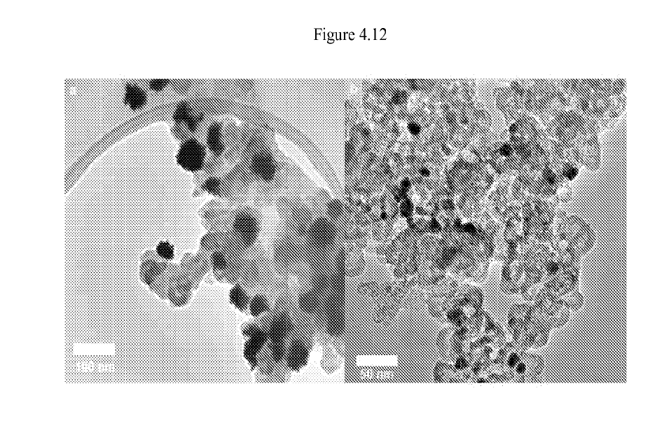

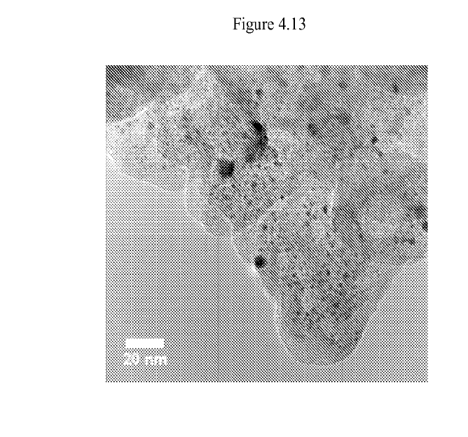

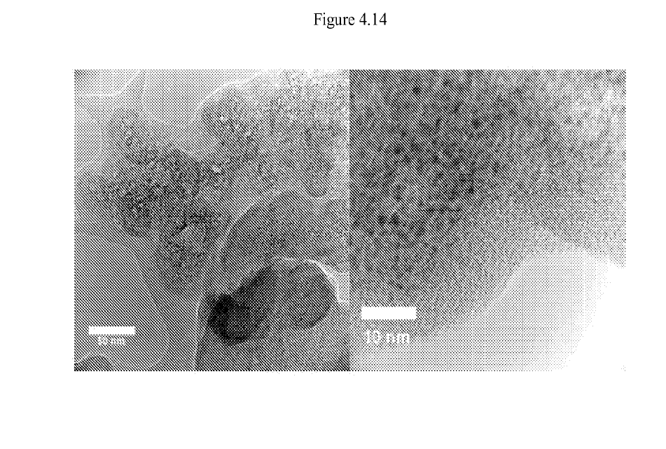

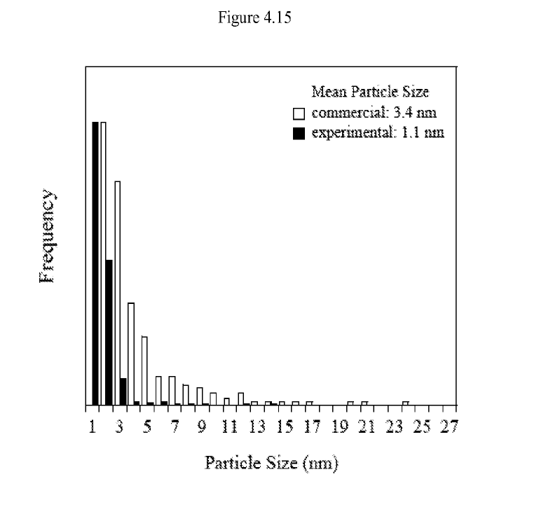

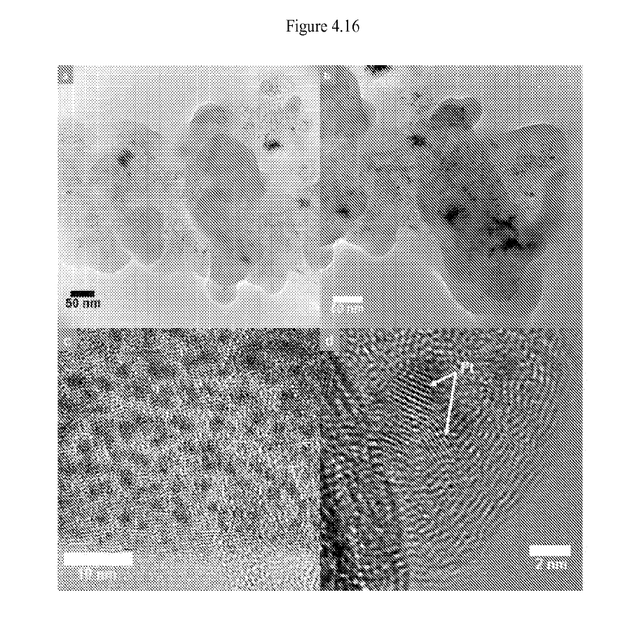

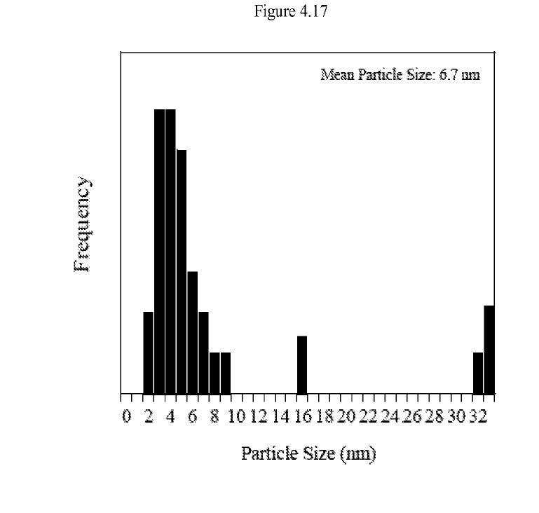

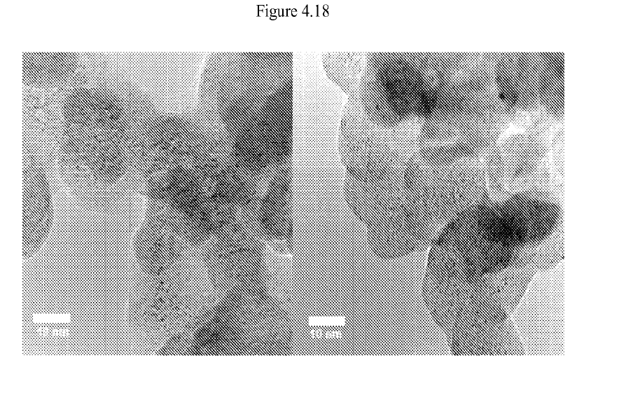

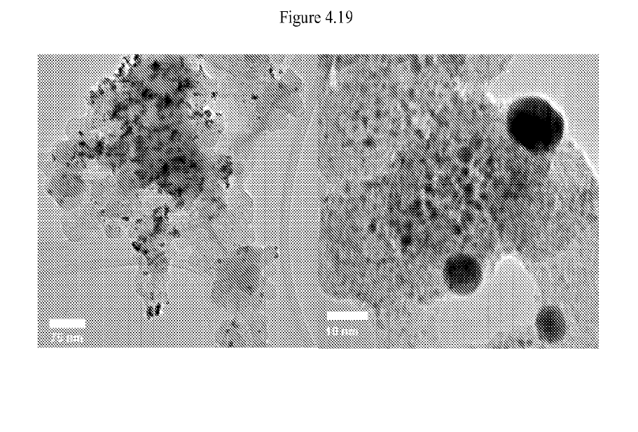

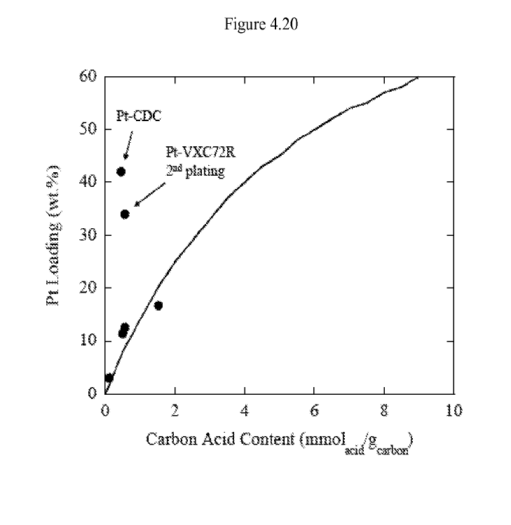

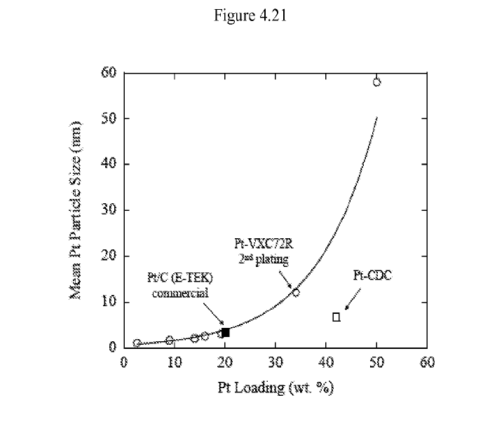

As is seen by reference to FIG. 4.21, metallized carbonaceous material produced by the claimed methods achieves a greater metal at lower particle sizes than do commercially-available materials, which in turn presents a higher surface area of metal at a given metal loading. Without being bound to any one theory of operation, it is believed that the claimed methods uncouple or disconnect, at least to some degree, the connection between metallic particle size and the loading of metallic particles. This connection, as discussed elsewhere herein, has historically posed a challenge to presenting a comparatively high surface area of metal at a relatively low, economical level of metal loading.

Carbonaceous materials suitable for use in the claimed method include a carbide-derived carbon, as described in PCT Application PCT/US2006/045154, by Gogotsi, et al., the entirety of which is incorporated herein by reference, carbon black, or any combination thereof. In some embodiments, the carbonaceous material is characterized as having a total specific surface area of between about 300 m²/g and about 5000 m²/g, as measured by the Brunauer-Emmet-Teller method, or of between about 500 m²/g and about 4000 m²/g, as measured by the Brunauer-Emmet-Teller method, or even of between about 1500 m²/g and about 2000 m²/g, as measured by the Brunauer-Emmet-Teller method. The carbonaceous material is suitably porous.

The claimed invention also includes metallized carbonaceous material produced according to the claimed methods.

Also disclosed are metallized carbonaceous compositions. The claimed compositions include a plurality of carbonaceous pores characterized as comprising a total specific surface area of between about 300 m²/g and about 5000 m²/g, as measured by the Brunauer-Emmet-Teller method, a plurality of metallic nanoparticles bound to at least a portion of the plurality of pores; and the plurality of metallic nanoparticles being present in a range of from about 1 to about 100 weight percent.

The plurality of metallic nanoparticles suitably has an average cross-sectional dimension in the range of from about 1 to about 60 nm, or from about 1 nm to about 30 nm, or from about 1 nm to about 5 nm. Suitable metallic nanoparticles can be platinum, ruthenium, palladium, tin, cobalt, or any combination thereof. Exemplary images of a CDC-derived catalyst are shown in FIG. 4.16, which is described in greater detail elsewhere herein.

The carbonaceous pores are suitably a carbide-derived carbon. A suitable carbide-derived carbon is described in Application PCT/US2006/045154, by Gogotsi, et al., the entirety of which is incorporated herein by reference. The carbonaceous pores may also be characterized as having a total specific surface area, as measured by the Brunauer-Emmet-Teller method, of from about 500 m²/g to about 4000 m²/g, or from about 1000 m²/g to about 3500 m²/g.

Also disclosed are electrodes. The claimed electrodes include an electrolytic material, a porous carbonaceous composition in contact with the electrolytic material, the porous carbonaceous composition characterized as suitably having a total specific surface area of between about 300 m²/g and about 5000 m²/g, as measured by the Brunauer-Emmet-Teller method. The electrodes also have a plurality of metallic nanoparticles, where at least a portion of the plurality of metallic nanoparticles are bound to at least a portion of the porous carbonaceous composition.

The porous carbonaceous composition, in some embodiments, is characterized as having a total specific surface area of between about 500 m²/g and about 4000 m²/g, or between about 1500 m²/g and about 2000 m²/g, as measured by the Brunauer-Emmet-Teller method. The porous carbonaceous composition is suitably a carbide-derived carbon, as described elsewhere herein.

Electrolytes suitable for the claimed electrode are capable of permitting the passage of ions. As an example, Nafion™ (DuPont; www.dupont.com), a sulfonated polymer, is considered especially suitable. Other proton conductors are also suitable. Electrolytic materials may be solids, and, in some embodiments, may include one or more pores. Polymers, fluids, alkalais, carbonates, acids, oxides, and the like are all considered suitable. The ultimate selection of an electrolytic material will depend on the user's needs and will be apparent to those having ordinary skill in the art. Electrolytic materials capable of conducting protons are considered especially suitable.

The metallic nanoparticles of the claimed electrode can be platinum, ruthenium, palladium, tin, cobalt, or any combination thereof. Other suitable metals will be apparent to those having ordinary skill in the art.

Suitably, the plurality of metallic nanoparticles is present in the range of from about 1 to about 100 weight percent based on total weight of the composition, or in the range of from about 10 to about 70 weight percent based on total weight of the composition, or in the range of from about 20 to about 50 weight percent based on total weight of the composition. The optimal weight percentage—loading—of the metallic nanoparticles will depend on the user's needs or other constraints including, for example, cost.

The plurality of metallic nanoparticles typically has an average characteristic cross-sectional dimension in the range of from about 1 nm to about 60 nm, as discussed elsewhere herein.

The claimed invention also provides energy cells; energy cells are also, in certain cases, referred to as fuel cells. The claimed energy cells suitably include an electrolytic material separating an anode and a cathode, at least a portion of the anode, at least a portion of the cathode, or both, being in contact with a carbonaceous composition, the carbonaceous composition being characterized as having a total specific surface area of between about 300 m²/g and about 5000 m²/g, as measured by the Brunauer-Emmet-Teller method; and a plurality of metallic nanoparticles bound to at least a portion of the carbonaceous composition. In some embodiments, the carbonaceous material is sprayed, glued, bonded, painted, printed, or otherwise applied to the cathode, anode, or both. The optimal methods for applying the material to the cathode or anode will be dictated by the needs of the user.

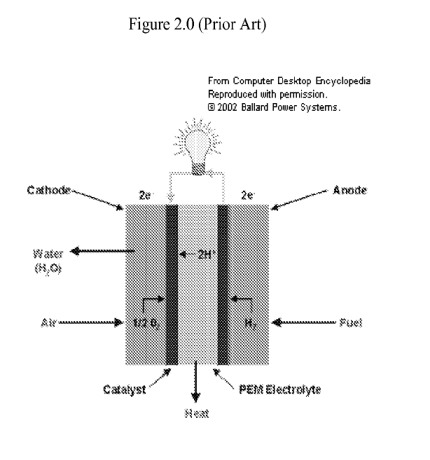

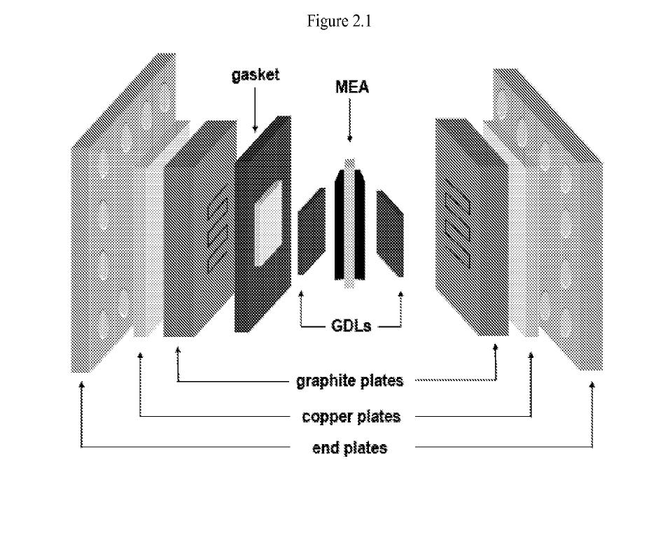

The anode and cathode of the energy cell are suitably in ionic communication with one another, as shown in non-limiting prior art FIG. 2.0. The electrolytic material of the claimed energy cells suitably is a polymeric material capable of conducting protons, such as Nafion™, although other materials capable of conducting protons are also suitable.

Suitable metallic nanoparticles and their presence as a function of weight percentage are described elsewhere herein.

The claimed energy cells include one or more regions capable of placing one or more chemical agents in contact with the anode. Such agents are methanol, water, oxygen, alcohols, acids, bases, and the like. Methanol is considered particularly suitable for reasons of cost and availability. Chemical agents will be chosen by the user according to their needs and application constraints.

The claimed energy cells further include at least one conduit in fluidic communication with one or more of the one or more regions capable of placing one or more chemical agents in contact with the anode. Such conduits permit, for example, the passage of a fluid past the anode or the removal of fluid from the energy cell. Suitable energy cells also include one or more regions capable of placing one or more chemical agents in contact with the cathode, and, in some embodiments, include at least one conduit in fluidic communication with one or more of the one or more regions capable of placing one or more chemical agents in contact with the cathode.

In certain embodiments, the energy cells include a heat source. Such heat sources may be used to provide heat to chemical agents, fluids, or to the energy cell itself as needed to optimize the functioning of the cell.

Suitable energy cells include ionic connection between the energy cell and a power consumer. Such a connection could be, for example, an electrical connection between the energy cell and a motor, an electronic device, a source of illumination, a source of heat, a source of heat removal, an engine, a transmitter, a charge storage device, or any combination thereof. In some embodiments, the energy cell powers a vehicle, or even a building. Energy cells are portable, in some embodiments, such as where they may be used in a vehicle.

Carbonaceous compositions suitable for use in the claimed energy cells include carbide-derived carbons, as described elsewhere herein.

Further disclosed are methods for metallizing a carbonaceous material. These methods include forming a plurality of charged groups on a surface of the carbonaceous material, contacting the plurality of charged groups with a salt comprising a plurality of metallic ions, where the contacting giving rise to a plurality of metallic ions binding to the plurality of charged groups; and neutralizing the charge on at least a portion of the plurality of bound metallic ions so as to give rise to a plurality of metallic nanoparticles bound to the surface of the carbonaceous material.

The plurality of metallic nanoparticles suitably is characterized as having an average characteristic cross-sectional dimension in the range of from about 1 nm to about 60 nm, and the metallic nanoparticles are present in at greater than about 1 weight percent based on total weight of the composition. Suitable ranges for nanoparticle weight percentages and sizes are discussed elsewhere herein.

Formation of the charged groups on the surface of the carbonaceous material includes contacting the carbonaceous material with an oxidant or a reductant, as described elsewhere herein. Suitable oxidants are described elsewhere herein, as are suitable charged groups.

Contacting the charged groups with metallic salts is also described elsewhere herein, as are suitable metallic salts. As described elsewhere herein and as depicted in the figures, the contacting of the metallic salts to the charged groups is characterized as an ion-exchange.

At least a portion of the bound metallic nanoparticles is neutralized by a chemical composition. In some embodiments, the charge on at least a portion of the bound metallic ions is neutralized by a composition comprising hydrazine, sodium borohydride, sodium dithionite, formaldehyde, or any combination thereof. In other embodiments, the charge on at least a portion of the plurality of bound metallic ions is neutralized by a composition comprising an acid, such as sulfuric acid.

Neutralization of the bound metallic ions may, as described elsewhere herein, be suitably accomplished by chemical agents. In other embodiments, the neutralization is performed by application of gas. The gas is suitably heated, typically to between about 200° C. to about 1000° C. Air, molecular hydrogen, argon, or any combination thereof, are all considered suitable gases.

The claimed methods include, in some embodiments, the step of washing at least a portion of the plurality of bound metallic ions. The washing step is described elsewhere herein.

The claimed methods also, in some embodiments, include a secondary plating step. Secondary plating steps are also described elsewhere herein.

Carbonaceous material characterized as having a total specific surface area of between about 300 m²/g and about 5000 m²/g, or of between about 1500 m2/g and about 4000 m2/g, or between about 2500 m2/g and about 3000 m2/g, as measured by the Brunauer-Emmet-Teller method, is considered suitable for the claimed methods. Carbide-derived carbon is considered an especially suitable carbonaceous material, as are porous carbonaceous materials.

The metallized carbonaceous material produced according the claimed methods is also within the scope of the claimed invention.

Further provided are methods for metallizing carbonaceous materials. These methods include forming a plurality of charged groups on a surface of the carbonaceous material, the carbonaceous material suitably characterized as having a total specific surface area of between about 300 m²/g and about 5000 m²/g, as measured by the Brunauer-Emmet-Teller method; contacting the plurality of charged groups with a salt comprising a plurality of metallic ions, the contacting giving rise to a plurality of metallic ions binding to the plurality of charged groups; and neutralizing the charge on at least a portion of the plurality of bound metallic ions with a so as to give rise to a plurality of metallic nanoparticles bound to the surface of the carbonaceous material. A schematic of the claimed methods is given in FIG. 1.7.

Formation of the charged groups on the surface of the carbonaceous materials, contacting the plurality of charged groups with a salt comprising a plurality of metallic ions and giving rise to metallic ions being bound to the carbonaceous material are all described elsewhere herein. Neutralizing the charge on the bound metallic ions, by chemical agent and by application of gas, is also described elsewhere herein.

These methods also, in some embodiments, include the step of washing at least a portion of the plurality of bound metallic ions, which washing step is described elsewhere herein. The claimed methods also include, in some embodiments, a secondary plating step, which step is described elsewhere herein.

Suitable metallic nanoparticles are described elsewhere herein, both in terms of their weight percent and in terms of their average characteristic cross-sectional dimensions.

The metallized carbonaceous material produced according to the claimed methods is also within the scope of the claimed invention.

### NON-LIMITING EXAMPLES AND REPRESENTATIVE EMBODIMENTS

The following examples are representative embodiments only and do not necessarily limit the scope of the present invention.

Materials

Catalyst Development

Commercially available carbon blacks, Vulcan® XC72R (Cabot), Ketjenblack® EC300JD and Ketjenblack® EC600JD (Akzo Nobel), along with experimental carbon material, carbide-derived carbons (CDC), received from the Department of Materials Science and Engineering, Drexel University, (Y. Gogotsi and M. Barsoum's Laboratories) were used as supports for precious metal catalysts. Nitric acid (Aldrich, 70%, ACS grade) and potassium permanganate (Aldrich, 99.999% purity) solutions were used to chemically oxidize the carbon supports. Ethylene glycol (Aldrich, 99.999% purity) was used as a dispersing agent for untreated carbon supports. Ultra-pure reverse osmosis deionized (DI) water (resistively ˜16 MΩ cm) was used for preparing aqueous solutions. Whatman® polycarbonate (PC) Nucleopore® Track-Etch Membrane filters (Fisher, 0.4 μm pore size) were used to separate oxidized carbon particles from acidic solutions. Tetraamine platinum (II) hydroxide, TAPH, (Pt(NH)₄(OH)₂, Alfa Aesar, 8-11 wt. % Pt) was used for the ion-exchange reaction with oxidized carbon supports and hexachloroplatinic(IV) acid, HCPA, (H₂PtCl₆, Alfa Aesar, 99.9% purity) was used for the colloidal method of platinum deposition. Whatman® polypropylene (PP) filters (Fisher, 0.4 pore size) were used to separate the Pt/C complex from basic solutions. Argon gas (Airgas, 99.9% purity) was used to purge oxygen from the furnace during thermal reduction of the Pt/C catalyst. Sodium borohydride (Aldrich, 99.99% purity) was used in the chemical reduction of the Pt/C catalyst.

Membrane Electrode Assembly

The anode and cathode electrodes were composed of catalyst and Nafion®. A commercially available solution of Nafion® (1100 EW, 5 wt % Nafion® in solution of water and alcohols; Ion Power and 1100 EW, 5 wt. % Nafion® in solution of water and alcohols; Aldrich) was used in the formation of the catalyst ink. A 3:1 ratio (v/v) of DI water and isopropanol, IPA, (Aldrich, 99.999% purity) was used as the dispersing agent for the catalyst and Nafion®. Both experimental and commercial catalysts were used in preparing electrodes. Commercial carbon supported platinum catalysts include: 20 wt. % and 50 wt. % Pt on Vulcan® XC72R (VXC72R; E-TEK). The commercial carbon supported platinum-ruthenium catalyst used was 20 wt. % Pt/10 wt. % Ru on Vulcan® XC72R (E-TEK). The commercial unsupported Pt and Pt—Ru catalysts used were HiSPEC™ 1000 (Pt black; Alfa Aesar) and HiSPEC™ 6000 (Pt—Ru black, 50:50 atomic %; Alfa Aesar), respectively. Teflon coated fiberglass decals (CS Hyde Co.) were used as substrates for the fabrication of the electrodes. Single-sided GDL (A-6 ELAT/SS/NCN2.1; E-TEK) and double-sided GDL (A-7 ELAT/DS/NCN2.1; E-TEK) were used at the cathode and anode electrodes, respectively. When the hand-painted GDL technique was used, single-sided and double-sided GDLs were used as the electrode substrates for the cathode and anode, respectively.

Nafion® NRE-212 (0.051 mm, 1100 EW, DuPont; Ion Power), Nafion® 115 (0.127 mm, 1100 EW, DuPont; Ion Power), Nafion® 117 (0.178 mm, 1100 EW, DuPont; Aldrich) and Nafion® 1110 (0.254 mm, 1100 EW, DuPont; Ion Power) membranes were used for the preparation of MEA. Nafion® NRE-212 comes with a protective coating on both sides of the membrane and was used as received after removal of the backing layers. All other membranes were purified in a 3% aqueous solution of hydrogen peroxide (Aldrich, 99.99% purity), washed in DI water, acidified in a 1 M aqueous solution of sulfuric acid (Aldrich, 99.999% purity), and washed again in DI water.

Fuel Cells

Ultra pure hydrogen gas (<10 ppm CO, Airgas) was used as the anode fuel for PEMFC operation. Aqueous methanol (Aldrich, ACS reagent grade) solutions were used as the anode fuel for DMFC operation. Compressed air (Airgas) was used as the cathode fuel for both PEMFC and DMFC operation. Nitrogen gas (Airgas) was used for fuel cell startup and leak tests. DI water was used to humidify the anode and cathode gas streams. Gaskets were used to separate the anode and cathode current collectors and to isolate the electrode area. Virgin PTFE Teflon® gaskets (0.127 mm; McMaster Carr) were used for Nafion® NRE-212 membranes (PEMFC operation) and ethylene propylene diene monomer (EPDM) gaskets (0.715 mm, Fuelcellstore.com™) were used for thicker membranes (DMFC and PEMFC operation).

Materials Characterization

Lacey carbon coated 200 mesh copper grids (SPI Supplies® Brand) were used for TEM imaging of carbon and catalyst samples. Ethanol (Aldrich, 99.99% purity) was used to disperse samples for TEM viewing.

Catalyst Development

Carbon Support Surface Oxidation

Three methods of carbon surface oxidation were explored. They include refluxing and mixing carbon in a mixture of potassium permanganate and nitric acid solutions adapted from K. Yasuda and Y. Nishimura, The deposition of ultrafine platinum particles on carbon black by surface ion-exchange-increase in loading amount, Materials Chemistry and Physics 82 (2003) 921-928, sonication of carbon in a nitric acid solution, and refluxing carbon in a nitric acid solution. For the first method, “as-received” carbon was dispersed in a solution containing equal parts of a 60 wt. % aqueous nitric acid solution and a 2 N aqueous potassium permanganate solution. The resulting dispersion was 0.2 wt. % solids. The mixture was refluxed (˜110° C.) and stirred for 4 hrs. The solids were vacuum filtered, using the PC filters, and dried in a convection oven at 40° C.

For the second method, as-received carbon was dispersed in a 50 wt. % aqueous nitric acid solution. The solid contents ranged between 0.1-1.0 wt. %. The mixtures were sonicated at room temperature (22-26° C.) in a bath with a fixed frequency and power output (ultrasonicating bath Cole-Parmer 8890; 42 kHz, 70 W) for 4 hrs. Carbon/acid mixtures were also sonicated with a variable power output sonifier (Branson Sonifer 450; 20 kHz, 120-260 W) for 10-15 min. When sonicating at high power stainless steel beakers were used in place of Pyrex® glassware. The resulting solids were vacuum filtered, using PC filters, and dried at 40° C.

For the third method, as received carbon supports were refluxed (˜110° C.) in a 50 wt. % aqueous nitric acid solution for 4 hrs. Solid contents ranged between 0.1-1.0 wt. %. The resulting solids were filtered, using PC filters, and dried at 40° C.

Platinum Deposition

Two methods of platinum deposition were explored in this study. They include an ionexchange reaction of platinum cation complexes to the negatively charged surface of oxidized carbon supports and physical adsorption of platinum colloids onto the surface and into the pores of untreated carbon supports.

For the ion-exchanged method, oxidized carbon solids were dispersed in DI water at 0.1 wt. % solids and stirred for 4-8 hrs to allow for complete dispersion. The ion-exchange reaction was carried out by addition of the TAPH solution to the oxidized carbon dispersion. The reaction was stirred for 12-24 hrs. The resulting Pt/C complex was vacuum filtered, using PP filters, and dried at 40° C. in a convection oven.

For the physical adsorption method of Pt deposition, as-received carbon was dispersed in ethylene glycol at 0.1 wt. % solids. The mixture was heated to 70° C. and stirred for 4-8 h. Physical adsorption of Pt colloids onto the carbon support was achieved by addition of HCPA to the glycol/carbon mixture. The pH of the mixture was made strongly basic by addition of a 1 M sodium hydroxide solution. The mixture was stirred and heated for an additional 8 h. The resulting Pt/C complex was filtered, using PP filters, and dried at 40° C.

Platinum Reduction

Reduction of platinum ions (deposited on the carbon surface) to metallic platinum was accomplished by thermal and chemical reducing methods. Thermal treatment was carried out in an inert atmosphere using a quartz flow-through chamber (Ace Glass) and a tube furnace (Barnstead Thermolyne 21100). Temperatures of 200-1000° C. were explored. Chemical reagents (sodium borohydride) were used for the reduction of the Pt/C complex. The Pt/C complex was dispersed in DI water (˜0.1 wt. % solids) and stirred for 4 h. Each reagent was added drop-wise in molar excess over 4-8 h. The resulting catalyst was vacuum filtered, using PP filters, and dried at 40° C. in a convection oven.

Secondary Plating

Nucleation of platinum onto existing platinum nano-particles of finished catalysts was carried out by a method of secondary plating. The secondary plating method was adapted from a process of depositing Pt onto a polymer film for actuator applications Phillips, A. K. and Moore, R. B., Ionic actuators based on novel sulfonated ethylene vinyl alcohol copolymer membranes, Polymer 46 (2005) 7788-7802. Ion-exchanged catalysts were dispersed in DI water (˜0.1 wt. % solids), heated to 40° C. and stirred for 4 h. The desired amount of TAPH was added to the mixture. An amount of 50:1 moles of sodium borohydride to moles of platinum was added in 8 increments over 4 h and the temperature was increased from 40° C. to 60° C. The resulting catalyst was vacuum filtered, using PP filters, and dried at 40° C. in a convection oven.

Membrane Electrode Assembly

Each MEA was composed of a Nafion® membrane sandwiched between an anode and cathode electrode. The electrodes were composed of catalyst and Nafion® ionomer. The composition of Nafion® within the electrode varied depending on its application. For DMFC operation the anode electrode contained 15 wt. % Nafion® and the cathode electrode contained 10 wt. % Nafion®. For PEMFC operation, both electrodes contained 30-40 wt. % Nafion®. MEAs were fabricated via a decal/hot-press method adapted from Wilson, M. and Gottesfeld, S., Thin-film catalyst layers for polymer electrolyte fuel cell electrodes, J. App. Electochem. 22 (1992) 1-7 and a painted GDL method. The painted GDL method was employed when using thinner membranes (0.051 mm; Nafion® NRE-212).

Electrode Fabrication

Catalyst ink was prepared by sonicating a mixture of catalyst, dispersed Nafion® ionomer (5 wt. % in solution), and an alcohol/water solution (3:1 ratio, v/v, IPA:DI water) for 30-60 min at 30° C. The ink composition was 5 wt. % catalyst with the balance Nafion® and solvent. Electrodes were prepared by hand-painting catalyst ink onto Teflon® coated fiberglass decals or GDLs, depending on the method of MEA fabrication. The electrode substrate (Teflon® decal or GDL) was cut to the desired area of the electrode (˜5 cm²) and the catalyst ink was applied (hand-painted) until the desired mass of precious metal was obtained.

Membrane Purification

As-received membranes (Nafion® N-115, Nafion® N-117, Nafion® N-1110) were purified prior to MEA fabrication. The membranes were cut to size (˜6 cm²) and refluxed in a 3% aqueous solution of hydrogen peroxide for 1 h. The resulting membranes were rinsed in DI water and then refluxed in DI water for 1 h. The membranes were then refluxed in a 1 M aqueous sulfuric acid solution for 1 h. Finally, the membranes were washed and refluxed in DI water for an additional hour. The resulting membranes were dried at ambient conditions.

Hot-Pressing

The anode and cathode electrodes were bound to the PEM as a result of elevated temperature and pressure. The Nafion® ionomer within the electrode acts as a binding agent for adhesion to the PEM. For the decal/hot-press method the temperature of the hot-press (Laboratory Press, Model C, Carver) was set to 150° C. The purified membrane was placed between the catalyst loaded Teflon® decals (anode and cathode electrodes) and then placed between virgin PTFE Teflon® (0.76 mm) to minimize contamination from the hot-press. The MEA was pressed to 13.8 MPa (2000 psi) for 30 s. The MEA was removed and cooled at ambient conditions. The Teflon® decals were peeled away leaving the electrodes attached to the PEM.

For the painted GDL method the temperature of the hot-press was set to 100° C. The purified membrane was placed between the catalyst loaded GDL and then placed between virgin PTFE Teflon® (0.76 mm) The MEA was pressed to 6.9 MPa (1000 psi) for 30 s. The MEA was removed and cooled at ambient conditions. MEA fabrication by this method incorporated the GDL into the MEA.

Fuel Cell

Fuel Cell Setup

MEAs were tested in a single cell Compact Fuel Cell Test Station 850C (5 amp; Scribner Associates Inc.). FIG. 2.1. is an expanded view of the fuel cell setup. MEA and GDL (single-sided on cathode electrode and double-sided on anode electrode) were placed between two graphite plates with 5 cm² serpentine gas flow fields. An electrically insulating gasket isolates the electrode active area and separates the graphite plates allowing for electron current to flow through the outer circuit. Copper plates were placed on the outside of each graphite plate for measuring voltage and applying load on the MEA. The fuel cell setup was assembled and held together with endplates and tie rods. Each endplate was equipped with a heating element and each tie rod was tightened to 11.3 N-m (100 lb-in) of torque. A leak test was performed with nitrogen gas to ensure complete seal of the gasket and integrity of the membrane. Fuel cell system parameters were monitored using Fuel Cell for Windows™ software, supplied by Scribner Associates Inc.

Fuel Cell Operation

For PEMFC operation, hydrogen gas was fed to the anode (0.42 LPM) and air was fed to the cathode (1.0 LPM). Each gas stream was humidified to 100% RH and heated to 80° C. The cell temperature was heated and maintained at 80° C. Back-pressure regulators maintained the pressure in the anode and cathode at 172 kPa (25 psig). MEA performance was characterized by polarization and power curves. Tests were conducted by adjusting the voltage from open-circuit voltage (OCV) to 0.1 V in increments of 0.02 V every 2.5 min and measuring the resulting current.

For DMFC operation, aqueous methanol solutions were fed to the anode, using an external peristaltic pump (MasterFlex® C/L, Cole Parmer) at a flow rate of 4 ml/min. Humidified air at 80° C. was fed to the cathode at 500 ml/min. Back-pressure regulators were set at ambient pressure (0 psig). MEA performance was characterized by polarization and power curves. MEA lifetime characterization was performed by measuring cell voltage as a function of time under a constant load of 100 mA/cm².

Materials Characterization

Transmission electron microscopy studies were performed at Penn Regional Nanotechnology Facility on a JEOL 2010 high resolution TEM. Powder samples were sonicated in ethanol and dispersed on a lacey carbon coated copper grid. The samples were dried at ambient conditions. High resolution imaging was performed at an accelerating voltage of 200 kV.

Raman spectroscopy was performed at the Centralized Materials Characterization Facility of the A. J. Drexel Nanotechnology Institute on a Renishaw 1000/2000 Raman spectrometer. Raman spectra were collected with an excitation wavelength of 514 nm in extended mode (800-2000 cm⁻¹).

Infrared spectroscopy was conducted using a Fourier-Transform Infrared (FTIR) spectrometer (Nicolet 6700 Series) equipped with a single-reflection diamond attenuated total reflectance (ATR) attachment (Specac, Inc., MKII Golden Gate™). Intrared spectra were collected at 4 cm⁻¹ resolution and 32 scans.

Conductivity of the carbon support was measured using alternating current (AC) electrical impedance spectroscopy (EIS). The frequency was scanned between 0.10 kHz and 1.0 MHz using a Solartron AC Impedance system (1260 impedance analyzer, 1287 electrochemical interface, Zplot software). Carbon/Nafion® pellets were prepared in similar composition to the electrodes used in MEAs. Dry mixtures of carbon and Nafion® were pressed using a Specac, Inc. press. Conductivity was measured normal to the plane of the pellet using a stainless steel two-electrode cell.

Carbon Supported Platinum Catalyst

Carbon supported platinum catalysts were prepared by the colloidal method and the method of ion-exchange. Commercially available carbon blacks and experimental carbide-derived carbons (CDC) were used as supports for platinum catalysts. Chemical surface treatment of the carbon provided a negatively charged surface which stabilized the primary particles in aqueous solution. Surface treatment also allowed for the ionexchange with Pt complexes. Reduction of the carbon-platinum complex produced the final catalyst with Pt in the metallic state. Thermal and chemical reduction methods were explored.

Carbon Support

Carbon Black

Carbon black is produced by the incomplete combustion of hydrocarbons, by burning natural gas and other oil fractions from petroleum with a limited supply of air Wohler, O., et al., Ullmann's Encyclopaedia of Industial Chemistry, vol. A5, VCH, Weinheim, 1986. During the combustion process cracking, polymerization and dehydrogenation produces spherical turbostratic carbon particles. Reaction with oxidizing components of the furnace gases leads to inherent surface acidic groups on the carbon Auer, E., Freund, A., Pietsch, J., Tacke, T., Carbons as supports for industrial precious metal catalysts, Applied Catalysis A: General 173 (1998) 259-271.

The desirable properties of carbon black are high porosity, large specific surface areas and electrical conductivity. Applications of carbon black include reinforcing and conducting additives for polymers, adsorbents, electrical storage devices and catalyst supports. Some physical properties of the carbon blacks used in this work are listed in Table 4.1.

Carbide-Derived Carbons

Carbide-derived carbon (CDC) is produced by the extraction of metals from carbides Gogotsi, Y., Carbon Nanomaterials. CRC Taylor & Francis Group, Boca Raton, 2006. In this work CDC produced from Ti₃SiC₂ was used as a catalyst support. The metals were etched by chlorination at a temperature of 800° C. CDC was used as received from the Department of Materials Science and Engineering (Y. Gogotsi and M. Barsoum's Laboratories) at Drexel University. It has been shown that CDC produced from Ti₃SiC2 has a narrow pore size distribution comparable to that of zeolites and single-wall carbon nanotubes. Yushin, G., et al., Synthesis of nanoporous carbide-derived carbon by chlorination of titanium silicon carbide, Carbon 43 (2005) 2075-2082. Applications of CDC include molecular sieves, gas storage, catalysts, adsorbents, electrodes, supercapacitors, water/air filters and medical devices Gogotsi, Y., et al., Nanoporous carbide-derived carbon with tunable pore size, Nature Materials 2 (2003) 591-594. Some physical properties of the CDC used in this work are presented in Table 4.1.

TABLE 4.1
Carbon Support Properties

| Carbon Support | SSA (m²/g) | Pore Volume (cm³/g) |
|---|---|---|
| VXC72R | 257 | 0.52 |
| KJ300 | 800 | 3.30 |
| KJ600 | 1400 | 4.95 |
| CDC | 1475 | 0.80 |

Carbon Support Oxidation

Two oxidation methods were explored: oxidation with nitric acid and oxidation with acid/potassium permanganate mixtures. Yasuda, K., et al., The deposition of ultrafine platinum particles on carbon black by surface ion-exchange-increase in loading amount, Materials Chemistry and Physics 82 (2003) 921-928, described a procedure for oxidation of carbon with a mixture of nitric acid and potassium permanganate. VXC72R and CDC were oxidized using this protocol.

The visual appearance of the carbon changed from a deep black pigment to a brownish purple pigment post oxidation. FIG. 4.1. shows TEM images of VXC72R and CDC as received and oxidized with a nitric acid/potassium permanganate mixture. From FIGS. 4.1(b) and 4.1(d) it appears that large crystals were deposited on the surface of the carbon support. Thermolysis results, shown later, demonstrated that these crystals were precipitate from the potassium permanganate in solution.

Chemical oxidation of carbon with nitric acid has been explored by numerous investigators. As-received carbon supports were refluxed in a 50 wt. % aqueous solution of nitric acid for 4 h. FIG. 4.2.(a) shows a TEM image of as-received VXC72R. The primary particle size of VXC72R was in the range of 20-60 nm. However, it was noted that large agglomerates, on the order of microns, are formed as a result of the hydrophobic carbon surface.

It has been shown that oxidation of various carbon allotropes has produced surface acidic sites with the majority of them carboxylic. Negatively charged surface acidic sites stabilize smaller carbon particles as a result of repulsive forces. The surface acidic sites are readily solvated with polar molecules allowing for homogenous dispersions in water. FIG. 4.2.(b) shows a TEM image of oxidized VXC72R. It was noted that the carbon agglomerate is less dense and that the primary particle size (−50 nm) has been preserved.

Samples of as-received carbon and oxidized carbon were burned in air (thermolysis) at 800° C. to degrade the carbon and test for residual solids deposited on the surface. Table 4.2. presents the results of this study. It was noted that thermolysis of the as-received CDC yielded trace amounts (<3 wt. %) of solids. This is most likely a result of residue metals left after etching of the metal carbide. Thermolysis of the carbon supports oxidized with acid/potassium permanganate mixtures yielded significant amounts (>75 wt. %) of residual solids. These results along with the TEM images (FIG. 4.1.) confirm the presence of a metal precipitate on the surface of the carbon support. The boiling point of manganese is 1962° C., therefore, it is probable that manganese deposited on the surface of the carbon support.

TABLE 4.2
Thermolysis Results of Carbon Samples

| | | Residual |
|---|---|---|
| Sample | | mass (wt %) |
| CDC | as-received | trace |
| CDC^{a} | oxidized | 78 |
| CDC^{b} | oxidized | trace |
| VXC72R | as-received | 0 |
| VXC72R^{a} | oxidized | 85 |
| VXC72R^{b} | oxidized | 0 |

^{a}Sonicated in HNO₃ and KMnO₄
^{b}Refluxed in HNO₃

VXC72R was treated in a 50 wt. % nitric acid solution under both sonicating (varying power output) and refluxing conditions. FIG. 4.3. shows the dependence of carbon particle size with treatment protocol and carbon acid content. It was observed that increasing the sonication power increased the carbon acid content to 0.11 mmol_{acid}/g_{carbon} and decreased the carbon particle size, by an order of magnitude, to ˜400 nm. Low powered sonication and reflux of the carbon support in a 50 wt. % aqueous solution of nitric acid (4 h residence time) achieved the same particle size (˜360 nm) but increased the carbon acid content by five-fold (0.55 mmol_{acid}/g_{carbon}).

Table 4.3. is a collective list of all carbon supports observed, oxidation protocol and support characterization. The support oxidation protocol shows sonication frequency, power output and length of time along with reflux time (if applicable). The support characterization shows the particle size analysis: mean particle size (50%), particle size at 95% of the sample (95%), the percentage of particles less than 204 nm (%<204 nm) and the carbon acid content.

TABLE 4.3
Carbon Support Oxidation Protocol and Characterization

| | | | | | Support Characterization | | | |
|---|---|---|---|---|---|---|---|---|
| | Support Oxidation | | | | Particle Size | | | Acid |
| Carbon | Freq. | Power | | Time | 50% | 95% | % <204 | Content |
| Type | (kHz) | (W) | Time | (h) | (nm) | (nm) | (nm) | (mmol/g) |
| VXC72R | 42 | 70 | 4 h | 4 | 361 | 1002 | 11% | 0.554 |
| VXC72R | 42 | 70 | 4 h | n/a | 4865 | 6298 | 0% | 0.110 |
| VXC72R | 20 | 120 | 10 min | n/a | 3458 | 5678 | 0% | 0.043 |
| VXC72R | 20 | 160 | 10 min | n/a | 3073 | 5312 | 1% | 0.057 |
| VXC72R | 20 | 200 | 10 min | n/a | 2895 | 5330 | 2% | 0.042 |
| VXC72R | 20 | 240 | 10 min | n/a | 814 | 4568 | 3% | 0.095 |
| VXC72R | 20 | 260 | 10 min | n/a | 450 | 2252 | 11% | 0.115 |
| KJ300 | 20 | 260 | 10 min | 1 | 242 | 502 | 37% | 1.519 |
| KJ600 | 20 | 260 | 10 min | 1 | 138 | 352 | 76% | 0.732 |
| CDC | n/a | n/a | n/a | 5 | 800 | 3304 | 27% | 0.451 |

FIG. 4.4. shows the maximum achieved carbon acid content for various supports with respect to specific surface area. Each sample was sonicated and then refluxed in a 50 wt. % aqueous nitric acid solution. This plot indicates that acid content is not a function of carbon surface area. Investigators have suggested that chemical bonding of acid groups on the carbon surface occurs primarily at graphitic edges (dangling bonds) and at defects within the structure.

Raman spectroscopy is a useful tool for characterization of crystalline and amorphous carbons. There are two notable peaks in the Raman spectra of disordered graphite: the disordered induced (D) band (˜1350 cm⁻¹) and the graphitic (G) band (1580-1600 cm⁻¹). The ratio of the intensity of the D-band to the intensity of the G-band (I_{D}/I_{G}) is a measure of the relative amount of disordered carbon to ordered graphitic carbon. Position and width of the peaks are a measure of the system order as well.

FIG. 4.5. shows the Raman spectrum of as-received VXC72R and oxidized VXC72R with varying carbon acid content. It was observed that the I_{D}/I_{G} ratio decreased with increasing acid contents. It was also observed that the G-band shifted to the right with increasing acid contents. Up-shift in the G-band is representative of an ordering system.

FIGS. 4.6 and 4.7 present Raman spectra of as-received and oxidized KJ300 and asreceived and oxidized KJ600, respectively. In both figures the same trend was observed as that of the VXC72R samples. The I_{D}/I_{G} ratio decreased, the spectra shifted to higher frequencies and the peaks became narrower with increasing acid content. The Raman spectra of the three carbon samples revealed increasing order of the system with oxidation. This suggests that chemical oxidation is preferential to the disordered carbon and at defect sites within the sample.

Catalyst Development

Colloidal Method of Platinum Deposition

The colloidal method of carbon support platinum catalyst preparation involves the formation of platinum metal colloids followed by adsorption onto the carbon support and reduction of the platinum complex to metallic form. The mechanism of colloidal deposition is physical adsorption on the surface and in the macropores of the carbon support. Commercial Pt/C catalyst (E-TEK) is prepared by the sulfite-complex route by addition of H₂PtCl₆ and NaHSO₃ in aqueous solution. FIG. 4.8. is a TEM image of carbon supported platinum commercial catalyst (E-TEK). The platinum loading measured was 18 wt. % and the mean platinum particle size was 3.4 nm.

FIG. 4.8. TEM image of carbon supported platinum commercial catalyst (E-TEK). Platinum loading: 18 wt. %, mean platinum particle size: 3.4 nm. Platinum metal colloids are also formed by the addition of H₂PtCl₆ in ethylene glycol. The mechanism of adsorption is similar to the sulfite-complex route where platinum colloids physically adsorb in the pores of the carbon support. FIG. 4.9. shows TEM images of carbon support platinum catalysts prepared by the glycol-complex route. Platinum reduction was achieved by thermal treatment in an inert atmosphere (Ar). The platinum loading measured was 6 wt. % and the mean platinum particle size was 2.6 nm. The targeted platinum loading was 20 wt. %.

Ion-Exchange Method of Platinum Deposition

Oxidized carbon was dispersed in an aqueous solution of tetraamine platinum (II) hydroxide (TAPH) and the reaction was carried out at room temperature. Due to the +2 charge on the tetraamine platinum cation and the −1 charge on the carboxylic anion it was expected that the stoichiometric reaction ratio (moles of platinum to moles of acid) would be ½. After ion-exchange, sufficient washing of the platinum-carbon complex insured fine dispersion of the platinum cations on the carbon surface.

FIG. 4.10. shows the final catalyst platinum loading (wt. %) as a function of TAPH concentration. The carbon support used was oxidized VXC72R and the carbon acid content was consistent at 0.55 mmol_{acid}/g_{carbon}. The maximum platinum loading achieved by ion-exchange was ˜16 wt. %. It was noted that at low concentrations of TAPH the catalyst loading is solely dependent on TAPH, following a linear trend, and at high TAPH concentrations the catalyst loading is a function of the carbon acid content. This behavior is indicative of Langmuir adsorption.

The Langmuir isotherm assumes a homogenous surface, as far as adsorption is concerned, with monolayer coverage of the adsorbent. Using the oxidized carbon support, VXC72R, with the maximum achieved acid content (0.55 mmol_{acid}/g_{carbon}) and by thorough washing of the carbon-platinum complex post ion-exchange, it was assumed that these two conditions were met. Linearization of the Langmuir isotherm yields the following equation:

$$\frac{1}{Θ} = 1 + \frac{1}{K [ TAPH ]} \qquad ( 4.1 . )$$

Where Θ is the fraction of the surface sites covered by platinum, K is the equilibrium rate coefficient and [TAPH] is the concentration of tetraamine platinum (II) hydroxide. As a result of the reaction stoichiometry, Θ is defined as:

$$Θ = \frac{{mol}_{Pt}}{2 {mol}_{acid}} \qquad ( 4.2 . )$$

FIG. 4.11. is a plot of 1/Θ with respect to 1/[TAPH]. From a linear regression analysis the slope and therefore the equilibrium rate coefficient was determined to be 0.106.

It was shown that adsorption of the tetraamine platinum (II) cation on oxidize carbon followed a Langmuir type. The amount of adsorbent was evaluated after ion-exchange, thorough washing of the platinum-carbon complex and thermal reduction in an inert atmosphere. It was assumed that all of the adsorbed platinum cations were reduced to metallic form. The platinum content was measured by thermolysis.

Platinum Reduction

Aqueous solutions of sodium borohydride (NaBH₄) and temperatures above 200° C. (under inert conditions) were used to promote nucleation of platinum nanoparticles. Methods of in-situ chemical reduction and washing prior to reduction were explored.

FIG. 4.12. (a) and (b) are TEM images of ion-exchanged carbon supported platinum catalysts reduced with NaBH₄. Oxidized VXC72R (0.55 mmol_{acid}/g_{carbon}) was used as the support and target Pt loadings were 70 wt. %. In FIG. 4.12 (a) in-situ chemical reduction was explored. The oxidized carbon support was dispersed in an aqueous solution with the TAPH. NaBH₄ was added drop-wise in molar excess to promote platinum nucleation. In FIG. 4.12 (b) the ion-exchange and chemical reduction were performed separately. The oxidized carbon (VXC72R) was ion-exchanged, filtered, washed and then reduced in an aqueous solution of NaBH₄. Again, NaBH₄ was added in molar excess (50:1).

Each reduction protocol yielded different results. In-situ reduction produced high platinum loadings with large platinum particles, whereas washing prior to reduction yielded low platinum loadings with smaller platinum particles. Image analysis and thermolysis revealed that the in-situ method of reduction produced a 50 wt. % platinum loading with a mean particle size of 58 nm. The method of washing prior to reduction produced a 17 wt. % platinum catalyst with a mean particle size of 14 nm.

Without being bound to any one theory of operation, it is believed that this suggests the in-situ method of reduction produced platinum particles via a nucleation and growth mechanism. The carbon acid sites acted to anchor platinum particles and additional ions from solution grew on the nucleated particles. Contrary to the in-situ method, the method of washing prior to reduction only allowed for the nucleation of ions that were adsorbed on the surface of the carbon support.

FIG. 4.13. is a TEM image of an ion-exchanged carbon supported platinum catalyst thermally reduced under an inert atmosphere. The oxidized carbon support was ionexchanged, filtered, washed and then reduced at 200° C. under an argon purge for 2 h. Image analysis and thermolysis revealed a 16 wt. % platinum catalyst with a mean particle size of 2.6 nm. It was noted that both chemical and thermal reduction methods, when the catalyst was washed prior to reduction, yielded similar platinum loadings. However, each method of reduction (thermal and chemical) produced different platinum particle sizes. Thermal reduction produced platinum particle sizes five-fold smaller than when chemical reduction was employed.

FIG. 4.14. shows TEM images of an ion-exchanged carbon supported platinum catalyst. The carbon (VXC72R; 0.1 mmol_{acid}/g_{carbon}) was ion-exchanged, filtered, washed and thermally reduced under Ar for 2 h. Image analysis and thermolysis revealed a platinum loading of 3 wt. % with a mean platinum particle size of 1.1 nm. The difference between catalysts presented in FIG. 4.14. and FIG. 4.13. was the carbon acid content support. The carbon support used in FIG. 4.13. had an acid content of 0.55 mmol_{acid}/g_{carbon} whereas the carbon support used in FIG. 4.14. had an acid content of 0.1 mmol_{acid}/g_{carbon}. It was noted that the support with a lower acid content yielded a catalyst with a lower platinum loading and a smaller particle size.

FIG. 4.15. compares the platinum particle size distributions for commercial (E-TEK) and experimental (ion-exchanged) carbon supported catalysts. It was noted that the ionexchanged catalyst has a narrower distribution and a mean particle size three-fold smaller than the commercial catalyst. From Equation 1.7. platinum surface area is inversely proportional to particle diameter.

FIG. 4.16. presents TEM images of CDC supported platinum catalyst. The acid content of CDC was 0.45 mmol_{acid}/g_{carbon}. The CDC was ion-exchanged in an aqueous solution with a target Pt loading of 60 wt. %. The catalyst was thermally reduced under Ar for 2 h. Image analysis and thermolysis revealed a platinum loading of 42 wt. % and a mean platinum particle size of 6.7 nm. From the TEM images it was noted that there were segregated areas of large platinum particles as well an array of small platinum particles.

It is believed that particle size analysis of the CDC supported catalyst, see FIG. 4.17, confirms the scattered distribution of platinum particles. It was revealed that the majority of particles were between 2-9 nm and that there were a few agglomerates of up to 33 nm.

Platinum Growth

It has been shown that platinum deposition onto oxidized carbon supports follows Langmuir adsorption and is a function of the surface acid content of the carbon. It was also revealed that in-situ chemical reduction formed platinum particles by a nucleation and growth mechanism whereas washing prior to reduction formed particles only from the platinum that was adsorbed on the surface of the carbon. It was hypothesized that the nucleation and growth mechanism could be segregated to control platinum loading and particle size. FIG. 4.18. presents an ion-exchanged carbon supported platinum catalyst that was thermally reduced. Image analysis and thermolysis revealed a platinum loading of 14 wt. % and a mean particle size of 2.1 nm. The finished catalyst presented in FIG. 4.18. was then added to an aqueous solution with an amount of TAPH that would yield a 35 wt. % platinum catalyst. NaBH₄ was added to the solution drop-wise, in molar excess, to promote growth on the existing platinum particles (secondary plating).

FIG. 4.19. presents TEM images of the carbon supported platinum catalysts prepared by secondary plating of platinum with NaBH₄. Image analysis and thermolysis revealed a platinum loading of 34 wt. % and a mean platinum particle size of 12.1 nm. It was noted that the yield was 97% and that the mean particle size increased by over five-fold.

FIG. 4.20. presents platinum catalyst loading as a function of carbon acid content for ion-exchanged catalysts. Contrary to FIG. 4.10. where the carbon acid content was held constant and the TAPH concentration was varied, in FIG. 4.20. different supports with varying acid contents were used under saturated TAPH concentrations (target Pt loadings were 60-70 wt. %).

Most of the ion-exchanged catalysts follow Langmuir adsorption. However, two catalysts deviate from the trend. As expected, the catalyst prepared by the method of secondary plating (platinum growth) does not follow monolayer surface (Langmuir) adsorption. However, unexpectedly the CDC supported platinum catalyst also does not follow Langmuir adsorption.

FIG. 4.21. presents mean particle size data as a function of platinum catalyst loading for carbon supported commercial catalysts (▪), ion-exchanged carbon supported catalysts (∘) and ion-exchanged CDC supported catalyst (□). It was noted that platinum particle size followed an exponential trend. However, platinum catalyst support on CDC did not follow the trend. The fact that CDC supported platinum catalysts obtain high platinum loadings with relatively small particle size is unexplained and poses great interest.

PEMFC Performance

Colloidal Catalyst

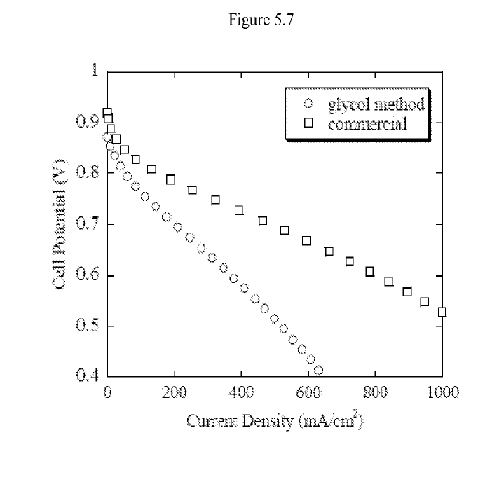

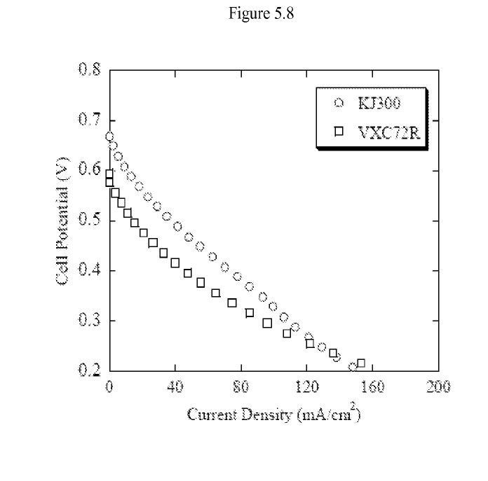

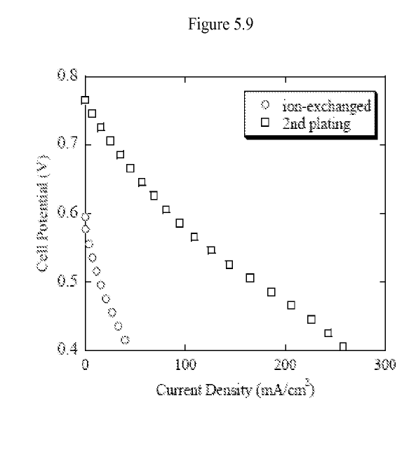

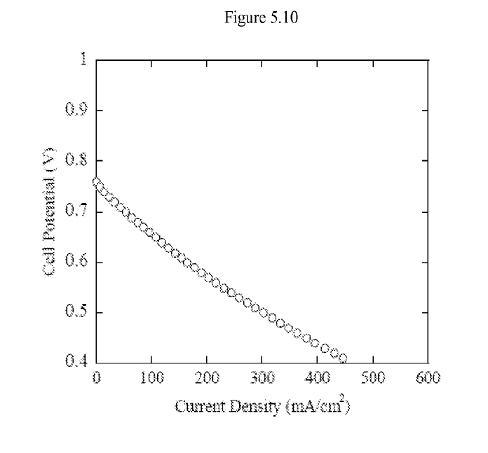

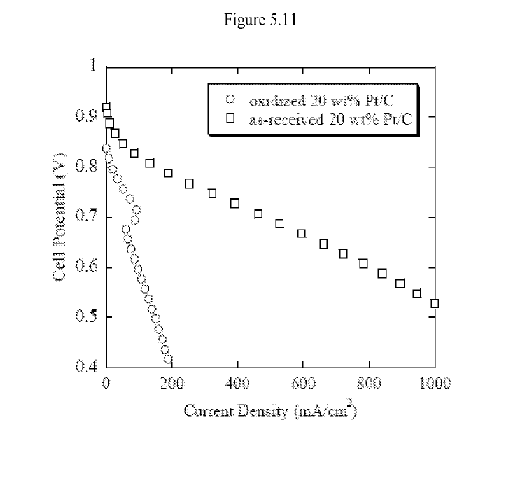

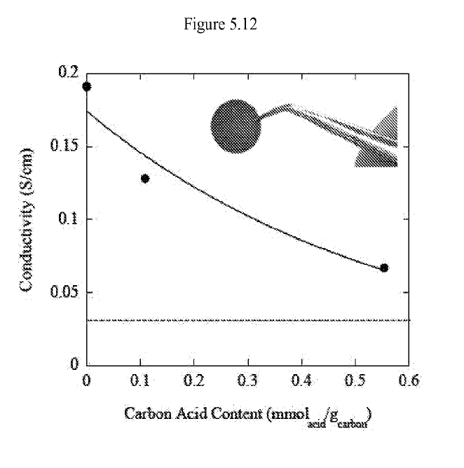

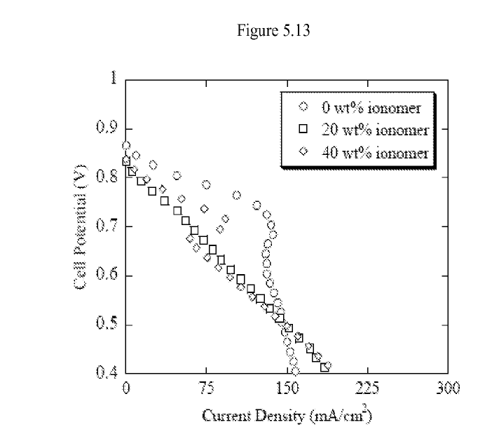

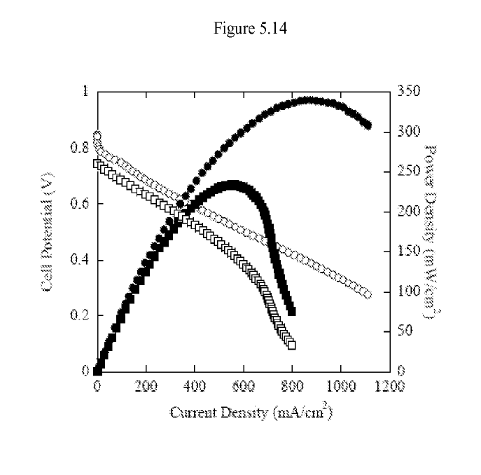

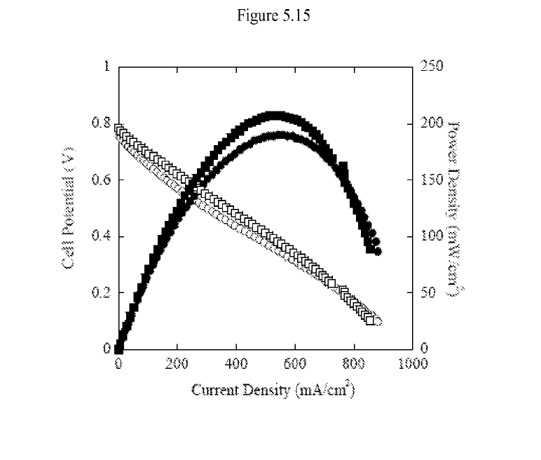

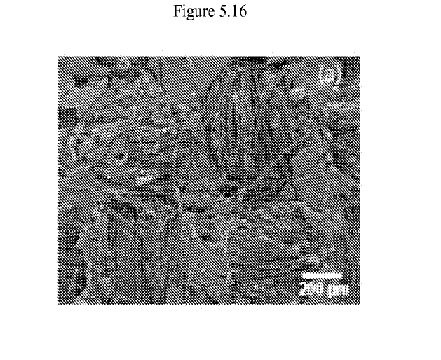

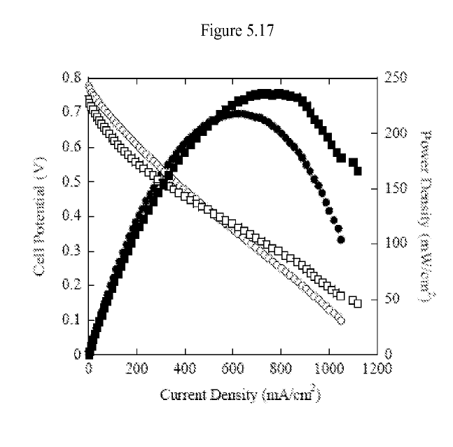

FIG. 5.7. presents PEMFC performance for commercial catalyst and experimental catalyst prepared by the glycol-method, described elsewhere herein. It was noted that the OCV was similar between both catalysts. This suggests that the reactivity of each catalyst is similar. However, under load, the performance of the experimental catalyst was lower in the ohmic and mass transfer regions. This may be a result of catalyst and/or electrode structures. The exposed Pt, the content of ionomer, the number triple point contacts and the porosity all play a role when the fuel cell is under load.

The Pt loading of the experimental catalyst was 6 wt. % Pt and the commercial catalyst was 20 wt. % Pt. As a result of the difference in Pt loadings, the experimental catalyst required thicker electrodes to obtain the same overall Pt content. The thickness of the electrodes may have contributed to the overall resistance and mass transport limitations of the MEA.

Ion-Exchanged Catalyst

Experimental catalysts were prepared by an ion-exchange method. Various carbons were oxidized and used as supports for Pt catalysts. FIG. 5.8. shows PEMFC polarization curves using Pt catalysts supported with VXC72R and KJ300. The catalyst Pt loadings were 16 wt. % and 19 wt. % for VXC72R and KJ300, respectively. It was noted that the performance of the ion-exchanged catalysts was significantly lower than the commercial and experimental catalysts (colloidal method) presented in FIG. 5.7. The OCV was ˜28% lower and the power output was ˜9 times lower than the colloidal catalyst and ˜25 times lower than the commercial catalyst.

FIG. 5.9. compares PEMFC performance for an ion-exchanged catalyst and a catalyst prepared by the method of secondary plating. The ion-exchanged catalyst Pt loading was 14 wt. %. The catalyst obtained by secondary plating had a Pt loading of 34 wt. %. TEM images revealed large crystal-like Pt particles ˜12 nm in diameter.

It was noted that the PEMFC performance increased with post secondary plating. The OCV increased by ˜27% and the power output increased five-fold. It is possible that the crystalline structure of the Pt (secondary plating) is more reactive than the spherical nano-particles of the ion-exchanged catalyst. However, the commercial catalyst Pt particles closely resembled the ion-exchanged Pt particles and showed superior performance over both catalysts.

FIG. 5.10. presents PEMFC performance for an ion-exchanged catalyst supported on CDC. Preparation and analysis the CDC supported Pt catalyst was presented in section 4.3.3., the Pt loading was 42 wt. % and the mean particle size was 6.7 nm. The CDC supported Pt catalyst did not follow the usual adsorption trends that other ion-exchanged catalysts followed. Likewise, it was noted that the Pt-CDC catalyst showed a different performance than the ion-exchanged catalysts presented above. The OCV increased by ˜22% and the power output increased over two-fold.

The Effect of Surface Oxide Groups

Many factors may have contributed to the inferior performance of the ion-exchanged catalysts. In section 4.3.3. it was shown that the ion-exchanged catalysts had mean Pt particle sizes 2-3 times smaller than commercial catalysts. This many have been a result of Pt particles deposited deeper in the pores of the carbon support, therefore, increasing the mass transfer resistance to reactants and lowering the accessibility of the ionomer phase (less triple point contacts).

Another major difference between the commercial and ion-exchanged catalysts was the presence of surface acid groups. Ion-exchanged catalysts have a greater number of acids groups as a result of chemical oxidation. In fact, the ion-exchanged catalysts were hydrophilic whereas commercial catalysts were hydrophobic. The hydrophilicity of the electrode may have induced flooding. It was previously shown that the cathode kinetics limit PEMFC performance. The additional flooding may have significantly affected the overall performance.

It was also noted that the surface oxide groups could have influenced electrode resistance. Surface oxide groups on carbon have been known to reduce electrical conductivity of the support. It was hypothesized that the electrical resistance of the electrode may limit the PEMFC performance.

FIG. 5.11 compares PEMFC performance for commercial catalyst, as-received and chemically oxidized in nitric acid. Thermolysis of the oxidized commercial catalyst was performed to confirm the Pt loading. The Pt loading was 16 wt. % Pt. It was noted that the performance of the commercial catalyst significantly decreased post oxidation. The performance was comparable to that of the ion-exchanged catalyst presented in FIG. 5.8. These results contradicted results presented by Jia and co-workers.

FIG. 5.12 presents conductivities for carbon-Nafion® composites as well as for a hydrated Nafion® PEM. The conductivity was measured using electrical impedance spectroscopy (EIS). Carbon blacks with varying acid contents were blended in solution with Nafion® (similar to the method of preparing catalyst ink). The resulting dispersion was dried and compressed into pellets containing 40 wt. % Nafion® (the same composition of PEMFC electrodes).

It was noted that the electrical conductivity of the carbon support decreased with increasing acid content. This was expected as the presence of oxygen containing groups are electrically insulating. It was also noted, however, that the proton conductivity of Nafion® is lower than the electrical conductivity of the carbon with the highest acid content. This shows that the limiting resistance within the MEA is the proton conductivity of Nafion®. Therefore, the presence of surface oxide groups should not contribute to lowered PEMFC performance.

It was further hypothesized that the optimum electrode Nafion® content changed as a result of changing the carbon surface characteristics. FIG. 5.13. compares PEMFC performance for oxidized commercial catalyst with varying Nafion® electrode content.

Performance did not change significantly for all amounts of electrode Nafion® content. MEA without Nafion® showed the best performance at low current densities, which, without being bound to any one theory of operation, suggests that the surface acidic groups contribute to proton transport. However, at current densities above ˜150 mA/cm² the load was too large for the weak conductivity and the fuel cell failed.

Electrode Structure

Catalyst ink and fabrication techniques influence the morphology of the electrode. A detailed description of catalyst ink preparation was discussed in section 2.3.1. FIG. 5.14 compares the PEMFC performance using commercial catalysts with different catalyst ink compositions. The catalyst inks were prepared using the same composition of catalyst and Nafion® but with different solvents: a 3:1 ratio of isopropyl alcohol (IPA) to DI water solution and a 100% DI water solution.

It was noted that the performance of the MEA prepared using the water-based catalyst ink differed from the MEA prepared using the IPA/water catalyst ink. The carbon supported commercial catalyst is hydrophobic. When dispersed in an aqueous solution the carbon particles tend to aggregate to minimize the exposed surface area.

It should also be noted that the overall performance of the commercial catalyst was lower than the performance presented in FIG. 5.1. The OCV was ˜12% lower and the maximum power output was ˜30% lower. This was a result of using a lower cathode Pt content (0.2 mg Pt/cm² compared to 0.43 mg Pt/cm²) as well as using a thicker PEM (Nafion® N117 compared to Nafion® NRE-212).

FIG. 5.15. compares the PEMFC performance using ion-exchanged catalysts with different catalyst ink compositions. Again, the catalyst inks were prepared using the same composition of catalyst and Nafion® but using different solvents:a 3:1 ratio of IPA to DI water solution and a 100% DI water solution. The MEA prepared with the water-based ink performed better than the MEA prepared with the IPA/water ink. It was observed that the ion-exchanged catalyst dispersed better in aqueous solution. This allowed for a homogeneous ink mixture which possibly contributed to optimum triple point contacts and exposed Pt particles.

Again, a lower cathode Pt content (0.2 mg Pt/cm²) and a thicker PEM (Nafion® N117) were used for the tests presented in FIG. 5.15. However, even with a low cathode Pt content and a thicker PEM, the performance presented in FIG. 5.15. was the highest achieved for the ion-exchanged catalysts. There was a ˜25% increase in both the OCV and the power output compared to the catalysts presented in FIG. 5.8.

It was noted that the ion-exchanged catalyst was a 3 wt. % Pt catalyst compared to the 16 wt. % Pt/VXC72R and 19 wt. % Pt/KJ300 catalysts presented in FIG. 5.8. From FIG. 4.22. it can be seen that the 3 wt. % Pt catalyst has an average particle size of 1.1 nm compared to 2.6 nm (16 wt. % Pt/VXC72R) and 3.3 nm (19 wt. % Pt/KJ300). This results in a ˜2-3 fold increase in available surface area for the 3 wt. % Pt catalyst.

Another point that should be discussed is the difference in MEA fabrication. The PEMFC results were performed on MEA fabricated by the decal/hot-press method, as apposed to the painted GDL method. It was noted that the ion-exchanged catalyst performed better when the MEA was prepared by the decal/hot-press method; however, the commercial catalyst performed better when using the painted GDL method.

In FIG. 4.3, carbon particle size decreased an order of magnitude from micron size agglomerates to nanometer size particles) upon chemical oxidation. Therefore, it was assumed, without being bound to any theory of operation, that the average particle size of ion-exchanged catalysts was on the order of nanometers, whereas the average particle size of commercial catalysts was on the order of microns. It is again mentioned that the ion-exchanged catalysts are hydrophilic and the commercial catalysts are hydrophobic.

FIG. 5.16. is a scanning electron micrograph of a GDL (as-received, E-TEK). The woven fibers and carbon coating are for the purpose of homogenous reactant diffusion over the electrode, electrical conductivity and the removal of water. It was noted that the spacing between the fibers are on the order of 1-10 μm. This is significantly larger than the ion-exchanged catalyst particles; however, it is on the same order of magnitude as the commercial catalyst particles.

FIG. 5.17. is a direct comparison of PEMFC performance using ion-exchanged catalyst and commercial catalysts. MEA were fabricated using the decal/hot-press method. The ion-exchanged catalyst ink was formulated using 100% DI water, whereas the commercial catalyst ink was formulated using the 3:1 ratio IPA/DI water solution.

1-26. (canceled)

27. A metallized carbonaceous composition, comprising: a carbide-derived carbon having a plurality of pores; and a plurality of metallic nanoparticles bound to at least a portion of the plurality of pores, the plurality of metallic nanoparticles being present in a range of from 1 to 100 weight percent based on total weight of the composition.

28. The metallized carbonaceous composition of claim 27, wherein the plurality of metallic nanoparticles comprises an average cross-sectional dimension in the range of from 1 to 60 nm.

29-30. (canceled)

31. The metallized carbonaceous composition of claim 27, wherein the plurality of metallic nanoparticles comprises platinum, ruthenium, palladium, tin, cobalt, or any combination thereof.

32. (canceled)

33. An electrode, comprising the metallized carbonaceous composition of claim 27 and an electrolytic material.

34-37. (canceled)

38. The electrode of claim 33, wherein the electrolytic material comprises a solid, a fluid, or a gel. (can be separated later in prosecution)

39-41. (canceled)

42. The electrode of claim 33, wherein the electrolytic material comprises a polymeric material comprising moieties capable of conducting protons.

43-51. (canceled)

52. An energy cell, comprising the metallized carbonaceous composition of claim 27 and an electrolytic material separating an anode and a cathode, at least a portion of the anode, at least a portion of the cathode, or both, being in contact with a carbide-derived carbon composition.

53. The energy cell of claim 52, wherein the anode and cathode are in ionic communication with one another.

54. The energy cell of claim 52, wherein the electrolytic material comprises a polymeric material capable of conducting protons.

55-60. (canceled)

61. The energy cell of claim 52, further comprising one or more regions capable of placing one or more chemical agents in contact with the anode or with the cathode or both.

62. The energy cell of claim 61, further comprising at least one conduit in fluidic communication with one or more of the one or more regions capable of placing one or more chemical agents in contact with the anode or with the cathode or both.

63-65. (canceled)

66. The energy cell of claim 52, further comprising an ionic connection between the energy cell and a power consumer.

67-70. (canceled)

71. A method for producing the composition of claim 27, comprising: providing a porous carbide-derived carbon, forming a plurality of charged groups on a surface of the carbide-derived carbon, contacting the plurality of charged groups with a salt comprising a plurality of metallic ions, the contacting giving rise to a plurality of metallic ions binding to the plurality of charged groups; and neutralizing the charge on at least a portion of the plurality of bound metallic ions so as to give rise to a plurality of metallic nanoparticles bound to the surface of the carbide-derived carbon.

72. The method of claim 71, wherein forming the plurality of charged groups on a surface of the carbonaceous material comprises contacting the carbide-derived carbon with an oxidant.

73. The method of claim 72, wherein the oxidant comprises nitric acid, hydrogen peroxide, oxygen, ozone, or any combination thereof.

74. The method of claim 72, wherein the plurality of charged groups comprises a carboxylic acid, a phenolic group, a lactonic group, an etheric group, or any combination thereof.

75. The method of claim 71, wherein the salt comprises Platinum (IV) oxide, PtO₂, Adams Catalyst, PtO₂—H₂O, Platinum(II) chloride PtCl₂, Hexahydroxyplatinic acid H₂[Pt(OH)₆], Platinum (IV) chloride PtCl₄, Ammonium chloroplatinite (NH₄)₂[PtCl₄], Potassium hexahydroxyplatinate K₂[Pt(OH)₆], Potassium chloroplatinite K₂[PtC₄], Chloroplatinic acid; CPA Crystal H₂[PtCl₆]-nH₂0, Chloroplatinic acid solution H₂[PtCl₆] (solution), Bromoplatinic acid H₂[PtBr₆]nH₂0, Sodium chloroplatinate hydrate Na₂[PtCl₆]xH₂0, Potassium chloroplatinate K₂[PtCl₆], Tetraammineplatinum(II) chloride hydrate Pt TPC crystal [Pt(NH₃)₄]Cl₂.nH₂O, Tetraammineplatinum(II) chloride solution Pt TPC solution [Pt(NH₃)₄]Cl₂, Hydrogen dinitrosulphatoplatinate(II) solution Pt DNS solution H₂[Pt(NO₂)₂SO₄] (solution), Dinitrodiammineplatinum Pt salt in ammoniacal solution [Pt(NHs)₂(NO₂)J, Tetraammineplatinum(II) nitrate solution [Pt(NH₃)₄(NO₃)₂ (solution), Sodium chloroplatinite solution Na₂[PtCl₄] (solution), Sodium hexahydroxyplatinate solution Na₂[Pt(OH)₆] (solution), Tetraammineplatinum hydroxide solution [Pt(NH₃)₄] (OH)₂ (solution), Tetraammineplatinum hydrogen phosphate Pt Q-SaIt—solution [Pt(NH₃)₄]HPO₄ (solution), Potassium trichloroammineplatinate(II) K[Pt(NH₃)Cl₃], Trans-diamminedichloroplatinum(II) trans[Pt(NH₃)₂Cl₂], Cis-diamminedichloroplatinum(II) cis [PtNH₃)₂Cl₂], Cis-dichlorobis(benzonitrile)platinum (II) PtCl₂(C₆HsCN)₂, Cis-dichlorobis(acetonitrile)platinum(II) Cis-Pt(CH₃CN)₂Cl₂, Bis(acetylacetonato)platinum(II) Pt(C₅H₇O₂)₂, Dichloro(norbornadiene)platinum(II) PtCl₂(C₇H₈), (Cycloocta-1,5-diene)diiodoplatinum(II) PtI₂(CsH1₂), Di-m-chlorodichlorobis(cyclohexene)diplatinum(II) [PtCl₂(C₆Hi₀)]₂, Potassium trichloro(ethylene)platinate(II) hydrate Zeise's Salt K[PtCl₃(C₂H₄)].H₂O, Cis-dichlorobis(triphenylphosphine)platinum(II) PtCl₂(PPh₃)₂, Potassium tetranitroplatinate(II) K₂[Pt(NO₂)₄], Trans-dichlorobis(diethylsulphide)platinum(II) trans-PtCl₂(Et₂S)₂, Cis-dichlorobis(triphenylphosphite)platinum(II) Pt[P(OPh)₂J₂Cl₂, Cis-dichlorobis(diethylsulphide)platinum(II) cis PtCl₂(Et₂S)₂, Potassium tetracyanoplatinate(II) K₂[PtCN)₄]Dichloro(1,5-cyclooctadiene)platinum(II) PtCl₂(CsHi₂), or any combination thereof.

76. (canceled)

77. The method of claim 71, wherein the charge on at least a portion of the bound metallic ions is neutralized by a composition comprising hydrazine, sodium borohydride, sodium dithionite, formaldehyde, or any combination thereof.

78. The method of claim 72, wherein the charge on at least a portion of the plurality of bound metallic ions is neutralized by a composition comprising an acid.

79. The method of claim 78, wherein the acid comprises sulfuric acid.

80-81. (canceled)

82. The method of claim 71, wherein the neutralizing is performed by application of a gas, comprising air, molecular hydrogen, argon, or any combination thereof, said gas heated to between 200° C. and 1000° C.

83-85. (canceled)

86. The method of claim 71, further comprising a secondary plating step.

87. The method of claim 86, wherein the secondary plating step comprises adsorbing colloidal metal to the surface of the carbonaceous material.

88. The method of claim 86, wherein the secondary plating step comprises contacting the carbonaceous material with a metallic salt followed by contacting the carbonaceous material with a chemical reductant.

89. The method of claim 71, wherein the carbonaceous material is characterized as comprising a total specific surface area of between about 300 m²/g and about 5000 m², as measured by the Brunauer-Emmet-Teller method.

90. The method of claim 71, wherein the carbonaceous material is characterized as comprising a total specific surface area of between about 1500 m²/g and about 4000 m²/g, as measured by the Brunauer-Emmet-Teller method.

91-93. (canceled)

94. The metallized carbonaceous material produced according to claim 71.

95-125. (canceled)

126. The composition of claim 27 wherein the carbide derived carbon is characterized as comprising a total specific surface area of between about 300 m²/g and about 5000 m²/g, as measured by the Brunauer-Emmet-Teller method.

127. The composition of claim 27, wherein the plurality of metallic nanoparticles is characterized as comprising from about 5 to about 50 weight percent of the total weight of the composition

128. The method of claim 71 wherein the plurality of metallic nanoparticles is characterized as comprising an average characteristic cross-sectional dimension in the range of from about 1 nm to about 60 nm.
